(19) United States
(12) Patent Application Publication
(10) Pub. No.: US 2026/0252996 A1
(43) Pub. Date: Aug. 27, 2026

(54) Systems and Methods for Combining User Actionable Items with Automated System Control Items in a Workflow

(71) Applicant: Moxo, Inc, Cupertino, CA (US)

(72) Inventors: He Huang, San Jose, CA (US); Subrah S. Iyar, Los Gatos, CA (US); Karrtik Rao Aria, Los Gatos, CA (US); Mukund C. Rao Aria, Los Gatos, CA (US)

(21) Appl. No.: 19/063,271

(22) Filed: Feb. 25, 2025

(51) Int. Cl. G06Q 10/0633

(52) U.S. Cl. CPC G06Q 10/0633

(57) ABSTRACT

Workflows include user actionable items and a system-triggered automation. Systems and methods for executing the workflows may: automatically communicate workflow presentation instructions to a user device to present the workflow to a user; electronically receive a request to integrate third-party data from a third-party web app into the workflow; automatically generate a system-triggered automation associated with the workflow to communicate with the third-party web app; automatically add a wait-until control item to the workflow to pause the workflow until the third-party data is received; dynamically update the workflow presentation instructions to include the wait-until control item; automatically complete the wait-until control item upon receiving the third-party data; automatically pass at least a portion of the third-party data to a subsequent item in the workflow; and dynamically updating the workflow presentation instructions to include the third-party data and updated status of: the wait-until control item and the subsequent item.

### BACKGROUND

Workflow management systems play a critical role in organizing and automating tasks, especially for business service teams implementing and managing complex services.

Conventional approaches to workflow management may include fully automated workflows. Many conventional approaches provide static system-to-system integration.

Problems may arise in conventional approaches for high-touch processes that require user input. Problems may also arise in conventional approaches when users desire workflow management in an efficient manner.

Accordingly, given the shortcomings of conventional approaches, a need exists for unconventional approaches that provide efficient workflow management.

This Background is provided to introduce a brief context for the Detailed Description that follows. This Background is not intended to be an aid in determining the scope of the claimed subject matter nor be viewed as limiting the claimed subject matter to implementations that solve any or all of the shortcomings or problems presented above.

### BRIEF DESCRIPTION OF THE SEVERAL VIEWS OF THE DRAWINGS

The accompanying drawings, which are incorporated in and constitute a part of this specification, illustrate several embodiments and, together with the description, serve to explain the disclosed principles. In the drawings:

FIG. 1 depicts an example environment for providing an automated workflow, consistent with disclosed embodiments.

FIG. 2 depicts an example process for communicating workflow instructions, consistent with disclosed embodiments.

FIG. 3 depicts an example system for executing workflows, consistent with disclosed embodiments.

FIG. 4 depicts an example process for integrating third-party data into a workflow, consistent with disclosed embodiments.

FIG. 5 depicts an example process for executing a workflow job service for adding a wait-until control item to a workflow with user actionable items, consistent with disclosed embodiments.

FIG. 6 depicts a first example process for automated workflow, consistent with disclosed embodiments.

FIG. 7 depicts an example computing device for automatically communicating workflow integration instructions to a system for executing workflows, consistent with disclosed embodiments.

FIG. 8 depicts an example process for automatically communicating with a system for executing workflows, consistent with disclosed embodiments.

FIG. 9 depicts a second example process for automated workflow, consistent with disclosed embodiments.

FIG. 10 illustrates an example workflow template presentation including first example options for adding items, consistent with disclosed embodiments.

FIG. 11 illustrates example options for configuring an automation, consistent with disclosed embodiments.

FIG. 12 illustrates example options for configuring a third-party web app, consistent with disclosed embodiments.

FIG. 13 illustrates example options for configuring a third-party web app account, consistent with disclosed embodiments.

FIG. 14 illustrates example options for configuring third-party web app inputs, consistent with disclosed embodiments.

FIG. 15 illustrates an example workflow template presentation including an example system-triggered automation, consistent with disclosed embodiments.

FIG. 16 illustrates an example workflow template presentation including an example wait-until control item, consistent with disclosed embodiments.

FIG. 17 illustrates an example workflow template presentation including second example options for adding items, consistent with disclosed embodiments.

FIG. 18 illustrates example options for adding details to a wait-until control item, consistent with disclosed embodiments.

FIG. 19 illustrates example options for configuring a wait-until control item, consistent with disclosed embodiments.

FIG. 20 illustrates example options for configuring wait-until control item data, consistent with disclosed embodiments.

FIG. 21 illustrates an example preview for adding a wait-until control item to a workflow, consistent with disclosed embodiments.

FIG. 22 illustrates an example workflow template presentation including third example options for adding items, consistent with disclosed embodiments.

FIG. 23 illustrates example options for configuring a third-party web app, consistent with disclosed embodiments.

FIG. 24 illustrates example options for configuring third-party web app integration data, consistent with disclosed embodiments.

FIG. 25 illustrates an example workflow presentation including an example wait-until control item in progress and example item details, consistent with disclosed embodiments.

FIG. 26 illustrates an example workflow presentation including an example wait-until control item in progress and an example collaboration feed, consistent with disclosed embodiments.

FIG. 27 illustrates an example workflow presentation including an example completed wait-until control item, consistent with disclosed embodiments.

FIG. 28 illustrates an example workflow presentation including an example launch web app action in progress, consistent with disclosed embodiments.

FIG. 29 illustrates an example workflow presentation including an example completed wait-until control item and example item details, consistent with disclosed embodiments.

FIG. 30 illustrates an example workflow presentation including an example subsequent user actionable item and example item details, consistent with disclosed embodiments.

FIG. 31 illustrates an example workflow presentation including an example completed launch web app, consistent with disclosed embodiments.

### DETAILED DESCRIPTION OF EMBODIMENTS

The disclosed embodiments provide unconventional systems, devices, and methods for providing and executing workflows that combine user actionable items and at least one system-triggered automation. The disclosed embodiments provide automated synchronization within a workflow of items requiring user input and system actions that may be fully automated. Embodiments consistent with the present disclosure are rooted in computer technology and may be implemented using a combination of conventional hardware and software as well as specialized hardware and software, such as one or more systems and/or devices constructed and/or programmed specifically for performing disclosed operations and/or functions associated with the disclosed methods. The following discloses example embodiments which are explanatory only and are not restrictive of the claims.

The disclosed systems and methods may provide a framework for representing a consultative workflow automatically. The disclosed systems and methods may provide context-aware workflows that are dynamically updated based on user interactions and fully automated system actions. The disclosed systems and methods may provide seamless integration of third-party data with workflows that combine user actionable items and at least one system-triggered automation. Workflows provided by the disclosed systems and methods may be integrated across multiple industries which may enable business organizations to streamline complex business service offerings. Workflows provided by the disclosed systems and methods may provide greater efficiency over conventional approaches that require data entry in multiple services.

The disclosed systems and methods provide greater efficiency over conventional approaches to automated workflow management, especially when workflows require human decision-making and interaction. The disclosed systems and methods provide greater efficiency over conventional approaches to complex service management that provide fragmented user experiences when users transition between systems or services that facilitate user actions and systems or services that facilitate automated system actions. The disclosed systems and methods provide greater effectiveness over conventional approaches that cause high error rates by providing outdated or inconsistent data presented to users. The disclosed systems and methods provide greater efficiency over conventional approaches that require utilizing separate workflow and collaboration applications. The disclosed systems and methods provide greater efficiency over conventional approaches that don't support reassigning one or more action items in a workflow from one user to another user.

As used herein, a workflow is a flow or sequence of action items and/or other items desired to reach a business goal. A sequence of action items and/or other items may be customizable. A sequence of action items and/or other items may be repeatable.

As used herein, an automated workflow is implemented in a computing environment. An automated workflow may be provided as part of a computer implemented workspace.

As used herein, a user actionable item is an action item or activity that is actionable to a user through employment of one or more of the disclosed systems and/or devices. A user actionable item may be associated with specific operations and/or functions that may be executed by the computer technology disclosed herein. A user actionable item may require interaction and/or consultative input from a user.

As used herein, a system-triggered automation is a system action item that is fully automated. In this disclosure, a system-triggered automation may be referred to as a system action, an automated system action, an automation item, or an automation in a workflow.

As used herein, a control item is an item that may be part of a workflow. A control item may be added to a workflow. A control item may be located before a sequence of user actionable items. A control item may be located after a sequence of user actionable items. A control item may be located between two user actionable items in a sequence of user actionable items.

As used herein, a collaboration feed is implemented in a computing environment. A collaboration feed may be provided as part of a computer implemented workspace. A collaboration feed may be configured to enable two or more users to communicate. A collaboration feed may be configured to illustrate a stream of communication content between two or more users. The two or more users may be associated with a specific workflow.

Embodiments consistent with the present disclosure may include a system for executing workflows. The system for executing workflows may be coupled to a computer network. The system for executing workflows may comprise at least one memory storing instructions. The system for executing workflows may comprise at least one processor configured to execute the instructions to perform operations. The operations may comprise automatically communicating workflow template presentation instructions to a first user device. The workflow template presentation instructions may be configured to present a workflow template to user of the first user device. The user of the first user device may be part of an internal team or workgroup. The workflow may comprise a sequence of user actionable items. The operations may comprise electronically receiving workflow integration instructions from the first user device. The workflow integration instructions may comprise a request to integrate third-party data from a third-party web app into the workflow. The operations may comprise automatically generating a system-triggered automation associated with the workflow. The system-triggered automation may be generated through employment of an integration module. The integration module may be configured to communicate with the third-party web app. The integration module may be configured to communicate with the third-party web app through employment of an Application Programming Interface (API). The operations may comprise automatically adding a wait-until control item to the workflow template. The wait-until control item may be configured to pause the workflow until the third-party data is received from the third-party web app. The operations may comprise dynamically updating the workflow template presentation instructions to include the wait-until control item in the workflow. The operations may comprise executing the workflow based on the workflow template. The operations may comprise automatically communicating workflow presentation instructions to a second user device. The workflow presentation instructions may be configured to present the workflow based on the workflow template to a user of the second user device. The user of the second user device may be part of an external team or workgroup. The operations may comprise automatically completing the wait-until control item upon receiving the third-party data from the third-party web app. The operations may comprise automatically passing at least a portion of the third-party data to one or more subsequent items in the workflow. Subsequent items may comprise items that appear after the system-triggered automation or the wait-until control item in the workflow. The operations may comprise dynamically updating the workflow presentation instructions to include the third-party data. The operations may comprise dynamically updating the workflow presentation instructions to include updated status of the wait-until control item. The operations may comprise dynamically updating the workflow presentation instructions to include updated status of the one or more subsequent items.

Some embodiments include third-party data. Third-party data may comprise data from a third-party system or application such as, for example, a third-party web app. Third-party data may comprise data related to the third-party system or application. Third-party data may comprise a notification that an event, operation, or record in the third-party system or application has been completed. One or more user actionable items in a workflow occurring after a wait-until control item in the workflow may be configured to reference third-party data. For example, a system for executing workflows may be associated with a first party. An external user of the system for executing workflows may be associated with a second party.

In some embodiments, a workflow may be configured for users external to a first organization. The users may be associated with a second organization. A third-party system or application such as, for example, a third-party web app may be provided by a third organization. The third-party system or application may be configured for users internal to the first organization. The third-party system or application may be hidden from the users external to the first organization. Links between the workflow and the third-party system or application may be hidden from the users external to the first organization.

In some embodiments, workflow integration instructions may be received from a user device while one or more user actionable items in a sequence of user actionable items remain actionable to a user of the user device. The ability for the user to utilize the user actionable items of a workflow may be referred to as being in the workflow. The ability for a user to supply and/or receive data from a third-party system or application while being in the workflow provides greater efficiency over conventional approaches that require separate and distinct access to the workflow and the third-party system or application. In these conventional approaches, there may not be any automation between one or more action items in the workflow and the third-party system or application.

In some embodiments, user actionable items past a wait-until control item in a workflow may be nonactionable to a user device until after the wait-until control item is complete. In these embodiments, the wait-until control item may be completed upon receipt of third-party data from a third-party system or application. The wait-until control item may be configured to present a list of data expected from the third-party system or application. The wait-until control item may be configured to present a status of the wait-until control item.

In some embodiments, operations may comprise dynamically updating workflow presentation instructions. Updated workflow presentation instructions may be configured to present one or more user actionable items past a wait-until control item being actionable. The items past the wait-until control item may be actionable after receiving third-party data from a third-party system or application. The operations may comprise automatically communicating the updated workflow presentation instructions to a user device.

In some embodiments, operations may comprise electronically receiving workflow modification instructions from a user device. The workflow modification instructions may comprise a request to modify a workflow. The operations may comprise automatically generating a modified workflow based on the workflow modification instructions.

In some embodiments, a request to modify a workflow may comprise adding a user actionable item. The user actionable item may be added to the workflow while a user is in the workflow.

In some embodiments, a request to modify a workflow may comprise removing a user actionable item. The user actionable item may be removed from the workflow while a user is in the workflow.

In some embodiments, a request to modify a workflow may comprise marking a user actionable item as complete. The user actionable item may be marked complete while a user is in the workflow.

Embodiments consistent with the present disclosure may include user actionable items. User actionable items may comprise a form, a file request, an approval, an acknowledgement, a signature, a calendar item, a task, an integration, and/or any other type of action item or activity employed to reach a business goal. A form may comprise an upload of a form, a completion of filling out a form, a download of a form, and/or any other type of form activity while a user is in a workflow. A file request may comprise requesting a file and/or fulfilling a request while a user is in the workflow. An approval may comprise approving a user actionable item by a user while the user is in the workflow. An acknowledgement may comprise acknowledging a user actionable item while a user is in the workflow. A signature may comprise signing a form and/or a document while a user is in the workflow. The signature may comprise an electronic signature. A calendar item may comprise adding an entry on a calendar and/or booking time on a calendar for one or more additional users while a user is in the workflow. For example, the entry on the calendar may be related to a call, a meeting, or a video meeting. A task may comprise assigning a task to one or more users while a user is in the workflow. A task may comprise a to do item.

An integration may comprise loading an external application from a third-party service provider while the user is in the workflow. For example, an external application may comprise a document signing application or an identity verification application. For example, an external application may comprise a third-party web app. A workflow may comprise one or more milestones. A milestone may comprise setting a milestone related to one or more user actionable items while a user is in the workflow.

In some embodiments, a user may be automatically notified of pending third-party data by a system for executing workflows. A user may be automatically notified by a system for executing workflows upon receiving third-party data. A user may be automatically notified by a system for executing workflows upon the completion of an event, operation, or record in a third-party system or application such as, for example, a third-party web app.

Some embodiments may include a workflow template database. The workflow template database may be configured to store a plurality of workflow templates. Each of the workflow templates may comprise a workflow having a sequence of user actionable items. At least some of the workflow templates may comprise a workflow having a sequence of user actionable items and at least one system-triggered automation.

In some embodiments, operations may comprise automatically communicating workflow template instructions to a user device. The workflow template instructions may be configured to present a plurality of workflow templates to a user of the user device. Each of the workflow templates may have a sequence of user actionable items. The operations may comprise electronically receiving a workflow template selection from the user device. The workflow template selection may comprise a request to select one of the workflow templates. The operations may comprise automatically communicating modified workflow template instructions to the user device. The modified workflow template instructions may be configured to present a specific workflow template to the user. The specific workflow template may be based on the workflow template selection.

In some embodiments, one or more user actionable items may be assignable to one or more users. Each of the one or more users may be associated with one or more workflow roles. User actionable items may be assignable dynamically. User actionable items may be assignable based on one or more of the workflow roles.

In some embodiments, operations may comprise electronically receiving reassignment instructions from a user device. The reassignment instructions may comprise a request to reassign one or more user actionable items from one user to another user. The operations may comprise automatically generating an updated workflow based on the reassignment instructions. The operations may comprise automatically communicating updated workflow presentation instructions to the user device. The updated workflow presentation instructions may be configured to present the updated workflow.

In some embodiments, reassignment instructions may be received from a user device while one or more user actionable items in a sequence of user actionable items remain actionable to a user of the user device.

Some embodiments may include a system-triggered automation. The system-triggered automation may include creating records in a third-party system or application such as, for example, a third-party web app. The system-triggered automation may include updating records in the third-party system or application. The system-triggered automation may include retrieving and processing data from the third-party system or application. The system-triggered automation may include triggering an event in the third-party system or application. The system-triggered automation may include triggering an operation in the third-party system or application.

In some embodiments, operations may comprise dynamically retrieving data from one or more user actionable items through employment of a Dynamic Data Reference (DDR) module. The operations may comprise dynamically referencing the data through employment of the DDR module. The operations may comprise dynamically utilizing the data through employment of the DDR module. The DDR module may be configured to prepare a new user actionable item.

In some embodiments, operations may comprise dynamically retrieving data from a system-triggered automation through employment of a Dynamic Data Reference (DDR) module. The operations may comprise dynamically referencing the data through employment of the DDR module. The operations may comprise dynamically utilizing the data through employment of the DDR module. The DDR module may be configured to prepare a new user actionable item.

Some embodiments may include a Dynamic Data Reference (DDR) module. The DDR module may be configured to dynamically retrieve, reference, and utilize workflow data from a user actionable item to prepare a new user actionable item. The DDR module may be configured to dynamically retrieve, reference, and utilize workflow data from a system-triggered automation to prepare a new user actionable item. The DDR module may be configured to automatically validate the workflow data against one or more prior item outputs. Prior item outputs may include output from any previous workflow item including: user actionable items, system-triggered automations, control items, and/or any other action items associated with a workflow. The DDR module may be configured to automatically populate the new user actionable item through employment of third-party data. The third-party data may be received from a third-party system or application such as, for example, a third-party web app. The third-party data may be retrieved from a third-party system or application.

Some embodiments may include a wait-until control item module. The wait-until control item module may be configured to automatically introduce a paused state in a workflow progression until third-party data is received from a third-party system or application such as, for example, a third-party web app. The wait-until control item module may be configured to automatically listen for the third-party data from the third-party system or application. The wait-until control item module may be configured to automatically retrieve the third-party data from the third-party system or application. The wait-until control item module may be configured to dynamically update dependent workflow items based on the third-party data. Dependent workflow items may include: user actionable items, system-triggered automations, control items, and/or any other items that are dependent on any portion of the third-party data. The wait-until control item module may be configured to resolve the paused state.

Some embodiments may include an automation module. The automation module may be configured to electronically communicate structured data from one or more user actionable items to a third-party system or application such as, for example, a third-party web app automatically. An example of structured data includes data submitted by a user in a form. The automation module may be configured to automatically retrieve third-party data from the third-party system or application. The automation module may be configured to automatically receive third-party data from the third-party system or application. The automation module may be configured to automatically process third-party data from the third-party system or application.

Some embodiments may include a launch web app module. The launch web app module may be configured to automatically add a launch web app action to a workflow template. The launch web app module may be configured to dynamically communicate one or more third-party web app requests from a user device to an integration module. The launch web app module may be configured to automatically communicate workflow data retrieved from one or more previous user actionable items to the integration module. The one or more previous user actionable items may be located before the launch web app action in the workflow. The launch web app module may be configured to automatically retrieve third-party data from a third-party web app. The launch web app module may be configured to automatically receive third-party data from a third-party web app. The launch web app module may be configured to automatically process third-party data from the third-party web app. The launch web app module may be configured to automatically generate interactive links for user interaction with the third-party web app.

Some embodiments may include a workflow management module. The workflow management module may be configured to automatically communicate completion of one or more user actionable items. The workflow management module may be configured to automatically communicate completion of a system-triggered automation. The workflow management module may be configured to automatically communicate current status of a wait-until control item. The workflow management module may be configured to automatically communicate pending third-party data. The workflow management module may be configured to automatically communicate a dependency between items consisting of one of the following: a first user actionable item and a second user actionable item, or a user actionable item and a system-triggered automation.

Some embodiments may include an audit database. Operations may comprise storing reassignment instructions in the audit database.

Some embodiments may include an audit database. Operations may comprise storing workflow integration instructions in the audit database.

In some embodiments, operations may comprise automatically communicating feed instructions to a user device. The feed instructions may be configured to present a collaboration feed to a user of the user device. The operations may comprise electronically receiving collaboration instructions from the user device. The collaboration instructions may comprise a request to add a collaboration item to the collaboration feed. The operations may comprise automatically generating a modified collaboration feed. The modified collaboration feed may be based on the collaboration instructions. The operations may comprise automatically communicating modified feed instructions to the user device. The modified feed instructions may be configured to present the modified collaboration feed to the user.

In some embodiments, collaboration instructions may be received from a user device while one or more user actionable items in a sequence of user actionable items remain actionable to a user of the user device. The ability for a user to request additions and/or view one or more additions to a communication feed related to a workflow while being in the workflow provides greater efficiency over conventional approaches where communication feeds and workflows are provided by separate applications.

In some embodiments, a collaboration item may comprise a message comprising text, a message comprising a video, a request for a video meeting, a file, a link to a file, a link to a data repository, an annotation, and/or any other type of collaborative content.

In some embodiments, a collaboration feed and/or a modified collaboration feed may be associated with a specific user actionable item in a workflow. In these embodiments, the collaboration feed and/or the modified collaboration feed may be available to users associated with the specific user actionable item.

In some embodiments, a collaboration feed and/or a modified collaboration feed may be associated with a workflow. In these embodiments, the collaboration feed and/or the modified collaboration feed may be available to users associated with the workflow.

Some embodiments may include an audit database. Operations may comprise storing collaboration instructions in the audit database.

Embodiments consistent with the present disclosure may include a computer-implemented method of executing workflows. One or more workflows may comprise user actionable items and at least one system-triggered automation. The method may comprise defining a workflow comprising a sequence of user actionable items. The method may comprise automatically communicating workflow template presentation instructions to a first user device. The workflow template presentation instructions may be configured to present a workflow template to a user of the first user device. The method may comprise electronically receiving workflow integration instructions from the first user device. The workflow integration instructions may comprise a request to integrate third-party data from a third-party web app into the workflow. The method may comprise automatically generating a system-triggered automation associated with the workflow. The system-triggered automation may be in communication with the third-party web app. The method may comprise automatically adding a wait-until control item to the workflow template. The wait-until control item may be configured to pause the workflow until the third-party data is received from the third-party web app. The method may comprise dynamically updating the workflow template presentation instructions to include the wait-until control item in the workflow. The method may comprise executing the workflow based on the workflow template. The method may comprise automatically communicating workflow presentation instructions to a second user device. The workflow presentation instructions may be configured to present the workflow based on the workflow template to a user of the second user device. The method may comprise automatically completing the wait-until control item upon receiving the third-party data from the third-party web app. The method may comprise automatically passing at least a portion of the third-party data to one or more subsequent items in the workflow. The method may comprise dynamically updating the workflow presentation instructions to include the third-party data. The method may comprise dynamically updating the workflow presentation instructions to include updated status of the wait-until control item. The method may comprise dynamically updating the workflow presentation instructions to include updated status of the one or more subsequent items.

In some embodiments, a method may comprise dynamically retrieving, referencing, and utilizing data from one or more user actionable items in a workflow in a new user actionable item.

In some embodiments, a method may comprise dynamically retrieving, referencing, and utilizing data from a system-triggered automation associated with a workflow in a new user actionable item.

In some embodiments, a method may comprise dynamically retrieving, referencing, and utilizing workflow data from a user actionable item to prepare a new user actionable item. The method may comprise automatically populating the new user actionable item through employment of third-party data.

In some embodiments, a method may comprise dynamically retrieving, referencing, and utilizing workflow data from a system-triggered automation to prepare a new user actionable item. The method may comprise automatically validating the workflow data against prior item outputs. The method may comprise automatically populating the new user actionable item through employment of third-party data.

In some embodiments, a method may comprise automatically introducing a paused state in workflow progression until third-party data is received from a third-party system or application such as, for example, a third-party web app. The method may comprise automatically listening for and retrieving the third-party data from the third-party system or application. The method may comprise dynamically updating dependent workflow items based on the third-party data. The method may comprise resolving the paused state.

In some embodiments, a method may comprise electronically communicating structured data from one or more user actionable items to a third-party system or application such as, for example, a third-party web app automatically. The method may comprise automatically retrieving and processing third-party data from the third-party system or application.

In some embodiments, a method may comprise automatically adding a launch web app action to a workflow template. The method may comprise dynamically communicating one or more third-party web app requests from a user device to a third-party web app. The method may comprise automatically communicating workflow data retrieved from one or more previous user actionable items to the third-party web app. The method may comprise automatically retrieving the third-party data from the third-party web app. The method may comprise automatically receiving the third-party data from the third-party web app. The method may comprise automatically processing the third-party data from the third-party web app.

Embodiments consistent with the present disclosure may include a computing device. The computing device may be coupled to a computer network. The computing device may comprise at least one memory storing instructions. The computing device may comprise at least one processor configured to execute the instructions to perform operations. The operations may comprise electronically receiving workflow template presentation instructions from a system for executing workflows. The workflow template presentation instructions may be configured to present a workflow template to a user. The workflow template may comprise a workflow having a sequence of user actionable items. The operations may comprise automatically communicating workflow integration instructions to the system for executing workflows. The workflow integration instructions may comprise a request to integrate third-party data from a third-party web app into the workflow. The operations may comprise electronically receiving updated workflow presentation instruction from the system for executing workflows. The updated workflow template presentation instructions may be configured to present an updated workflow template to the user. The updated workflow template may comprise an updated workflow having a wait-until control item. The wait-until control item may be configured to pause the workflow until the third-party data is communicated from the third-party web app to the system for executing workflows.

Embodiments consistent with the present disclosure may include a computing device. The computing device may be coupled to a computer network. The computing device may comprise at least one memory storing instructions. The computing device may comprise at least one processor configured to execute the instructions to perform operations. The operations may comprise electronically receiving workflow presentation instructions from a system for executing workflows. The workflow presentation instructions may be configured to present a workflow associated with a workflow template to a user. The workflow may comprise a sequence of user actionable items. The workflow may comprise a wait-until control item. The wait-until control item may be configured to pause the workflow until third-party data is communicated from a third-party web app to the system for executing workflows. The operations may comprise electronically receiving updated workflow presentation instructions from the system for executing workflows. The updated workflow presentation instructions may be configured to present an updated workflow to the user. The updated workflow may comprise an updated status of the wait-until control item. The updated workflow may comprise one or more subsequent user actionable items having received at least a portion of the third-party data.

In some embodiments, user actionable items past a control item in a workflow may be nonactionable to a user. The nonactionable condition may be temporary.

Embodiments consistent with the present disclosure may include electronically receiving updated workflow presentation instructions from a system for executing workflows. The updated workflow presentation instructions may be configured to present an updated workflow to a user. The updated workflow may comprise user actionable items past a control item being actionable to the user.

In some embodiments, a method may comprise electronically receiving feed instructions from a system for executing workflows. The feed instructions may be configured to present a collaboration feed to a user. The method may comprise automatically communicating collaboration instructions to the system for executing workflows. The collaboration instructions may comprise a request to add a collaboration item to the collaboration feed. The method may comprise electronically receiving modified feed instructions from the system for executing workflows. The modified feed instructions may be configured to present a modified collaboration feed to the user. The modified collaboration feed may be based on the collaboration instructions.

In some embodiments, collaboration instructions may be communicated to a system for executing workflows from a computing device while one or more user actionable items in a sequence of user actionable items remain actionable to a user of the computing device.

In some embodiments, a method may comprise electronically receiving workflow template instructions from a system for executing workflows. The workflow template instructions may be configured to present a plurality of workflow templates to a user of a computing device. Each of the workflow templates may have a sequence of user actionable items. The method may comprise automatically communicating a workflow template selection to the system for executing workflows. The workflow template selection may comprise a request to select one of the workflow templates. The method may comprise electronically receiving workflow template presentation instructions from the system for executing workflows. The workflow template presentation instructions may be configured to present a specific workflow template to the user. The specific workflow template may be based on the workflow template selection.

In some embodiments, one or more user actionable items may be assignable to one or more users associated with a workflow.

In some embodiments, a method may comprise automatically communicating reassignment instructions to a system for executing workflows. The reassignment instructions may comprise a request to reassign one or more user actionable items from one user to another user. The method may comprise electronically receiving updated workflow presentation instructions from the system for executing workflows. The updated workflow presentation instructions may be configured to present an updated workflow. The updated workflow may be based on the reassignment instructions.

In some embodiments, reassignment instructions may be communicated to a system for executing workflows from a computing device while one or more user actionable items in a sequence of user actionable items remain actionable to a user of the computing device.

Embodiments consistent with the present disclosure may include a method for automating workflow. The method may comprise electronically receiving workflow template presentation instructions from a system for executing workflows. The workflow template presentation instructions may be configured to present a workflow template to a user. The workflow template may comprise a workflow having a sequence of user actionable items. The method may comprise automatically communicating workflow integration instructions to the system for executing workflows. The workflow integration instructions may comprise a request to integrate third-party data from a third-party web app into the workflow. The method may comprise electronically receiving updated workflow presentation instruction from the system for executing workflows. The updated workflow template presentation instructions may be configured to present an updated workflow template to the user. The updated workflow template may comprise an updated workflow having a wait-until control item. The wait-until control item may be configured to pause the workflow until the third-party data is communicated from the third-party web app to the system for executing workflows.

Embodiments consistent with the present disclosure may include a method for automating workflow. The method may comprise electronically receiving workflow presentation instructions from a system for executing workflows. The workflow presentation instructions may be configured to present a workflow associated with a workflow template to a user. The workflow may comprise a sequence of user actionable items. The workflow may comprise a wait-until control item. The wait-until control item may be configured to pause the workflow until third-party data is communicated from a third-party web app to the system for executing workflows. The method may comprise electronically receiving updated workflow presentation instructions from the system for executing workflows. The updated workflow presentation instructions may be configured to present an updated workflow to the user. The updated workflow may comprise an updated status of the wait-until control item. The updated workflow may comprise one or more subsequent user actionable items having received at least a portion of the third-party data.

In some embodiments, a method may comprise electronically receiving workflow template instructions from a system for executing workflows. The workflow template instructions may be configured to present a plurality of workflow templates to a user. Each of the workflow templates may have a sequence of user actionable items. The method may comprise automatically communicating a workflow template selection to the system for executing workflows. The workflow template selection may comprise a request to select one of workflow templates. The method may comprise electronically receiving workflow template presentation instructions from the system for executing workflows. The workflow template presentation instructions may be configured to present a specific workflow template to the user. The specific workflow template may be based on the workflow template selection.

Reference will now be made in detail to example embodiments, examples of which are illustrated in the accompanying drawings and disclosed herein. The disclosed embodiments are described in sufficient detail to enable those skilled in the art to practice the disclosed embodiments. It is to be understood that other embodiments may be utilized and that changes may be made without departing from the scope of the disclosed embodiments. Thus, the components, methods, and examples are illustrative only and are not intended to be necessarily limiting. As will be appreciated by one skilled in the art, the components and arrangement of components included in the disclosed systems and devices may vary. For example, a system for executing workflows may further include other components or devices not depicted in the accompanying drawings that perform or assist in the performance of one or more processes consistent with the disclosed embodiments. In another example, a user device may further include other components or devices not depicted in the accompanying drawings that perform or assist in the performance of one or more processes consistent with the disclosed embodiments. In yet another example, a computing device may further include other components or devices not depicted in the accompanying drawings that perform or assist in the performance of one or more processes consistent with the disclosed embodiments. The components and arrangements shown in the accompanying drawings are not intended to limit the disclosed embodiments, as the components used to implement the disclosed processes and features may vary.

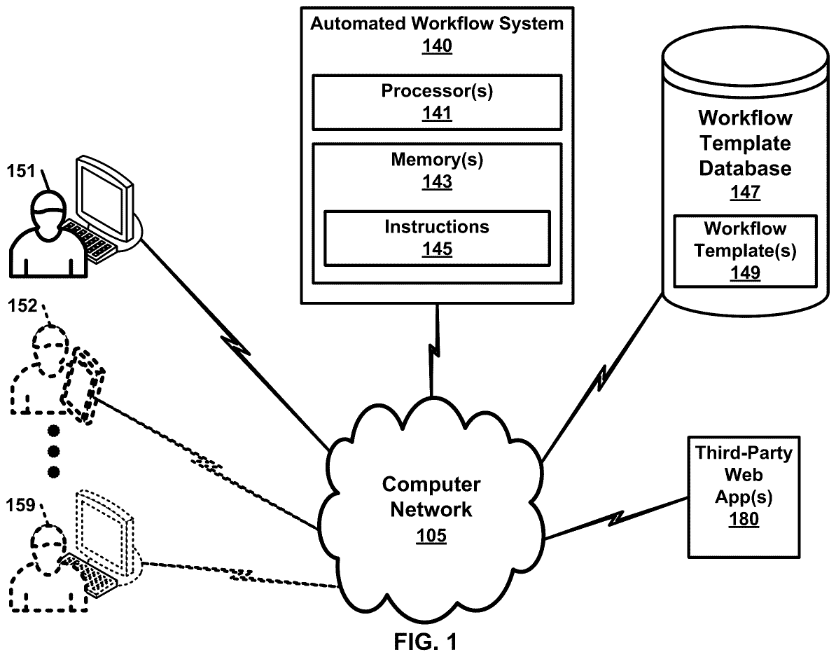

FIG. 1 depicts an example environment for providing an automated workflow, consistent with disclosed embodiments. Automated workflow system 140 may be communicatively coupled to computer network 105. An automated workflow system may be configured to execute workflows automatically. The automated workflow system 140 may comprise at least one memory 143. The at least one memory 143 may be configured to store instructions 145. The automated workflow system 140 may comprise at least one processor 141. The at least one processor 141 may be configured to execute the instructions 145 to perform operations. One or more user devices (151, 152, . . . 159) may be communicatively coupled to the computer network 105. A first of the user devices (151, 152, . . . 159) may be employed by a user internal to an organization. A second of the user devices (151, 152, . . . 159) may be employed by a user external to the organization. A workflow template database 147 may be communicatively coupled to the computer network 105. The workflow template database 147 may be configured to store one or more workflow templates 149. Each of the workflow templates 149 may comprise one or more workflows. Each workflow may comprise a sequence of user actionable items. One or more third-party web apps 180 may be communicatively coupled to the computer network 105.

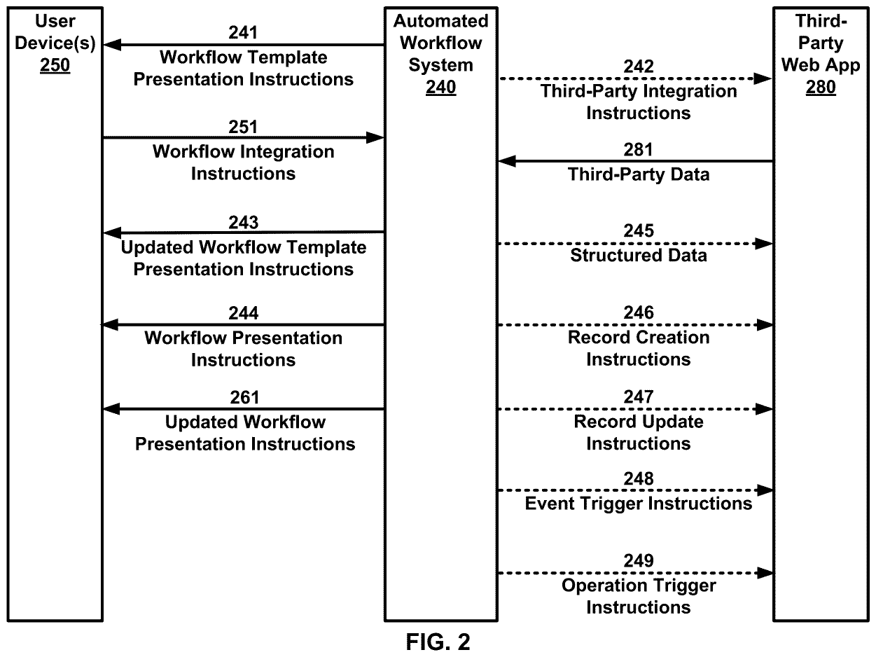

FIG. 2 depicts an example process for communicating workflow instructions, consistent with disclosed embodiments. Automated workflow system 240 may be configured to automatically communicate workflow template presentation instructions 241 to one or more user devices 250. The workflow template presentation instructions 241 may be configured to present a workflow template to one or more users of the user devices 250. The automated workflow system 240 may be configured to electronically receive workflow integration instructions 251 from one of the user devices 250. The workflow integration instructions 251 may comprise a request to integrate third-party data from a third-party web app 280 into a workflow based on the workflow template. The automated workflow system 240 may be configured to automatically communicate third-party integration instructions 242 to a third-party web app 280. The third-party integration instructions 242 may be communicated through employment of an integration module associated with the automated workflow system 240. A system-triggered automation may be generated and associated with the workflow. A wait-until control item may be added to the workflow. The workflow template presentation instructions may be dynamically updated to include the wait-until control item. The automated workflow system 240 may be configured to automatically communicate updated workflow template presentation instructions 243 to one or more of the user devices 250. The updated workflow template presentation instructions 243 may be configured to present the updated version of the workflow template to one or more users of the user devices 250. The workflow may be executed by the automated workflow system 240. The automated workflow system 240 may be configured to automatically communicate workflow presentation instructions 244 to one or more of the user devices 250. The workflow presentation instructions 244 may be configured to present the workflow to one or more users of the user devices 250. The automated workflow system 240 may be configured to automatically receive third-party data 281 from the third-party web app 280. The wait-until control item may be completed automatically upon receiving or soon after receiving the third-party data 281 from the third-party web app 280. The automated workflow system 240 may be configured to dynamically update the workflow presentation instructions to include the third-party data. The automated workflow system 240 may be configured to automatically communicate updated workflow presentation instructions 261 to one or more of the user devices 250. The updated workflow presentation instructions 261 may be configured to present the updated version of the workflow to one or more users of the user devices 250.

Automated workflow system 240 may be configured to electronically communicate structured data 245 to a third-party web app 280 automatically. The structured data 245 may be communicated through employment of an automation module associated with the automated workflow system 240. The automated workflow system 240 may be configured to electronically communicate record creation instructions 246 to the third-party web app 280 automatically. The record creation instructions 246 may be associated with a system-triggered automation. The record creation instructions 246 may be configured to request the creation of one or more records in the third-party web app 280. The automated workflow system 240 may be configured to electronically communicate record update instructions 247 to the third-party web app 280 automatically. The record update instructions 247 may be associated with a system-triggered automation. The record update instructions 247 may be configured to request the update of one or more records in the third-party web app 280. The automated workflow system 240 may be configured to electronically communicate event trigger instructions 248 to the third-party web app 280 automatically. The event trigger instructions 248 may be associated with a system-triggered automation. The event trigger instructions 248 may be configured to trigger one or more events in the third-party web app 280. The automated workflow system 240 may be configured to electronically communicate operation trigger instructions 249 to the third-party web app 280 automatically. The operation trigger instructions 249 may be associated with a system-triggered automation. The operation trigger instructions 249 may be configured to trigger one or more operations in the third-party web app 280.

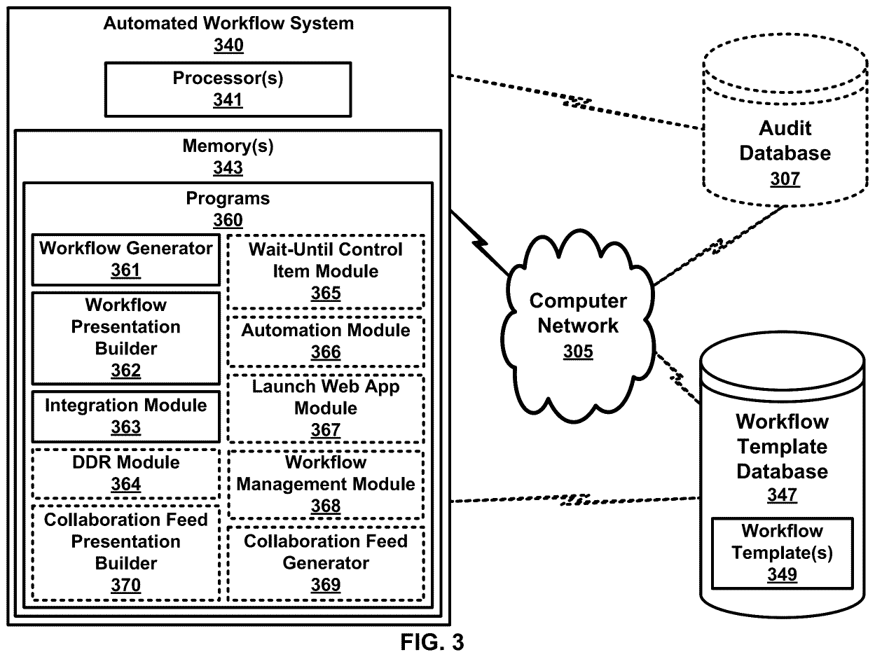

FIG. 3 depicts an example system for executing workflows, consistent with disclosed embodiments. Automated workflow system 340 may be communicatively coupled to computer network 305. The automated workflow system 340 may be communicatively coupled to workflow template database 347. The workflow template database 347 may be configured to store one or more workflow templates 349. Each of the workflow templates 349 may comprise one or more workflows. Each workflow may comprise a sequence of user actionable items. The automated workflow system 340 may be communicatively coupled to audit database 307. The automated workflow system 340 may comprise at least one memory 343. The at least one memory 343 may comprise one or more programs 360. Each of the programs 360 may comprise instructions. The automated workflow system 340 may comprise at least one processor 341. The at least one processor 341 may be configured to execute the instructions to perform operations. The programs 360 may comprise workflow generator 361. The workflow generator 361 may comprise workflow generating instructions. The programs 360 may comprise workflow presentation builder 362. The workflow presentation builder 362 may comprise workflow presentation building instructions. The programs 360 may comprise integration module 363. The programs 360 may comprise DDR module 364. The programs 360 may comprise wait-until control item module 365. The programs 360 may comprise automation module 366. The programs 360 may comprise launch web app module 367. The programs 360 may comprise workflow management module 368. The programs 360 may comprise collaboration feed generator 369. The collaboration feed generator 369 may comprise collaboration feed generating instructions. The programs 360 may comprise collaboration feed presentation builder 370. The collaboration feed presentation builder 370 may comprise collaboration feed presentation building instructions.

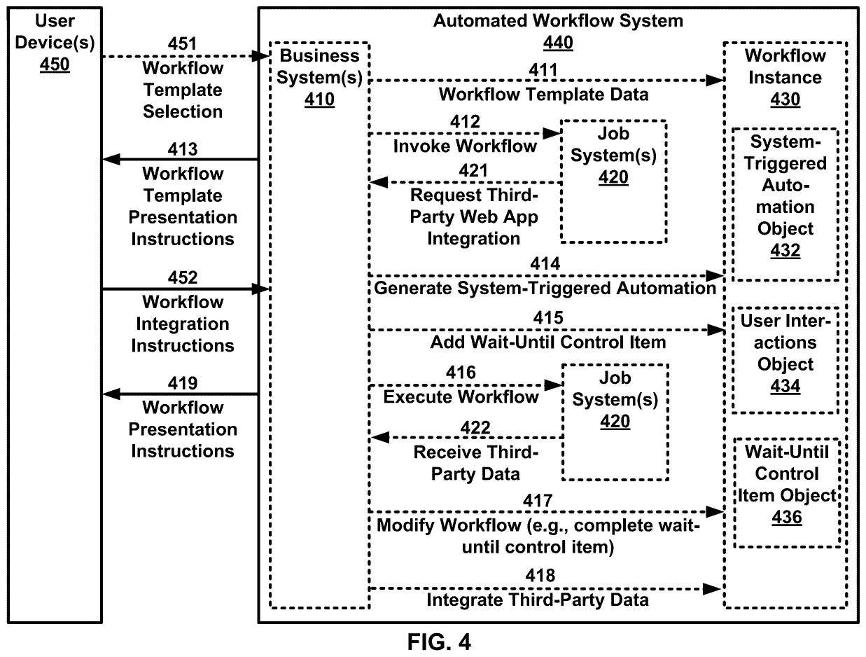

FIG. 4 depicts an example process for integrating third-party data into a workflow, consistent with disclosed embodiments. Automated workflow system 440 may comprise one or more business systems 410. The one or more business systems 410 may comprise at least one memory storing business instructions. The one or more business systems 410 may comprise at least one processor configured to execute the business instructions to perform business operations. The automated workflow system 440 may comprise one or more job systems 420. The one or more job systems 420 may comprise at least one memory storing job instructions. The one or more job systems 420 may comprise at least one processor configured to execute the job instructions to perform job operations. The business operations may comprise electronically receiving a workflow template selection 451 from a user device 450. The business operations may comprise creating a workflow instance 430 based on workflow template data 411. The workflow template data 411 may be based on the workflow template selection 451. The workflow instance 430 may comprise a system-triggered automation object 432. The system-triggered automation object 432 may comprise data required to generate a system-triggered automation associated with the workflow. The workflow instance 430 may comprise a user interactions object 434. The user interactions object 434 may be configured to store all user interactions associated with the workflow instance 430. The workflow instance 430 may comprise a wait-until control item object 436. The wait-until control item object 436 may comprise data required to add a wait-until control item to the workflow instance 430. The business operations may comprise communicating instructions to invoke a workflow job service 412 to one of the job systems 420. The job operations may comprise communicating a request for third-party web integration 421 into the workflow instance 430 to one of the business systems 410. After workflow template presentation instructions 413 are communicated to one or more user devices 450, the business operations may comprise receiving workflow integration instructions 452 from a user device 450. The business operations may comprise generating a system-triggered automation 414 in the system-triggered automation object 432 of the workflow instance 430. The business operations may comprise adding a wait-until control item 415 in the wait-until control item object 436 of the workflow instance 430. The business operations may comprise communicating instructions to execute the workflow 416 to one of the job systems 420. Workflow presentation instructions 419 may be communicated to one or more user devices 450. In the case that the next item in the workflow is a wait-until control item, the business operations may comprise receiving third-party data 422 from one of the job systems 420. The business operations may comprise modifying the workflow 417 in the workflow instance 430. For example, after receiving third-party data from a third-party system or application such as, for example, a third-party web app, the business operations may comprise completing a wait-until control item in the wait-until control item object 436. The business operations may comprise integrating third-party data 418 to one or more items in the workflow instance 430. After adding a wait-until control item 415, modifying the workflow 417, and/or integrating third-party data 418, updated workflow presentation instructions 419 may be communicated to one or more user devices 450.

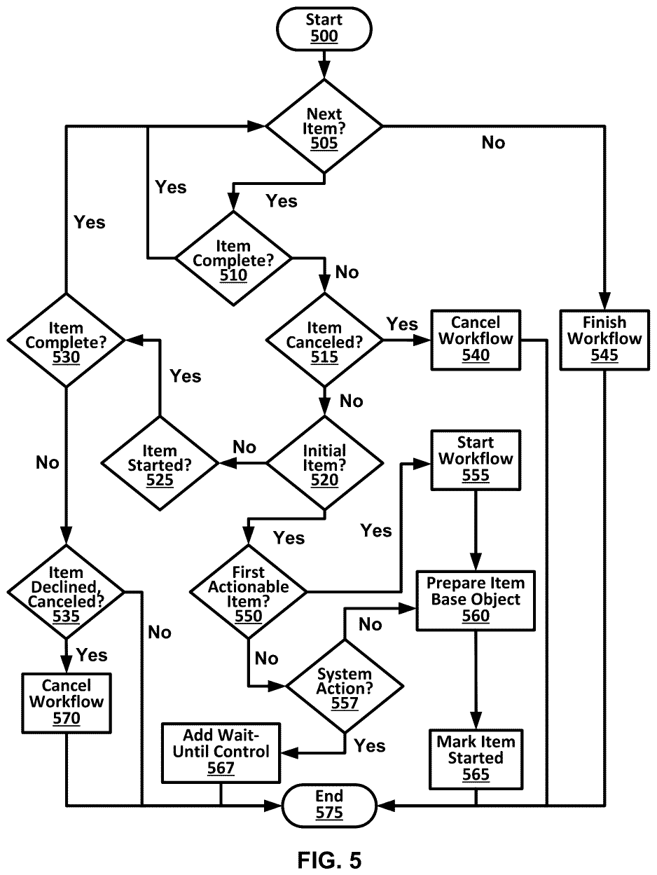

FIG. 5 depicts an example process for executing a workflow job service for adding a wait-until control item to a workflow with user actionable items, consistent with disclosed embodiments. The process may start at 500. Existence of a next item in a workflow may be determined at 505. A completion status of the next item may be determined at 510. A cancellation status of the next item may be determined at 515. An initial status of the next item may be determined at 520. A started status of the next item may be determined at 525. A completion status of the next item may be determined at 530. A determination of the next item being declined or canceled may be made at 535. The workflow may be cancelled at 540. The workflow may be finished at 545. A determination that the next item is the first user actionable item may be made at 550. The workflow may be started at 555. A determination that the next item is a system action item may be made at 557. The item base object may be prepared at 560. The item may be marked as started at 565. A wait-until control item may be added to the workflow at 567. The workflow may be cancelled at 570. The process may end at 575. The process may be repeated when the status changes for any item in the workflow.

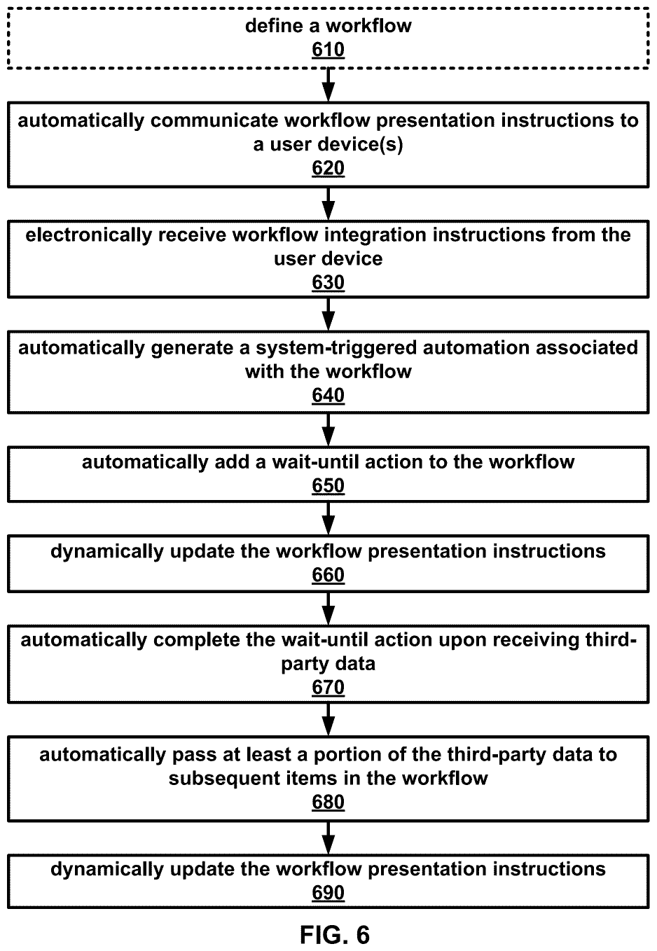

FIG. 6 depicts a first example process for automated workflow, consistent with disclosed embodiments. A workflow may be defined at 610. Workflow presentation instructions may be automatically communicated to one or more user devices at 620. Workflow integration instructions may be electronically received from one of the user devices at 630. A system-triggered automation associated with the workflow may be automatically generated at 640. A wait-until control item may be automatically added to the workflow at 650. The workflow presentation instructions may be dynamically updated at 660. The wait-until control item may be automatically completed upon receiving third-party data at 670. At least a portion of the third-party data may be automatically passed to one or more subsequent items in the workflow at 680. The workflow presentation instructions may be dynamically updated at 690.

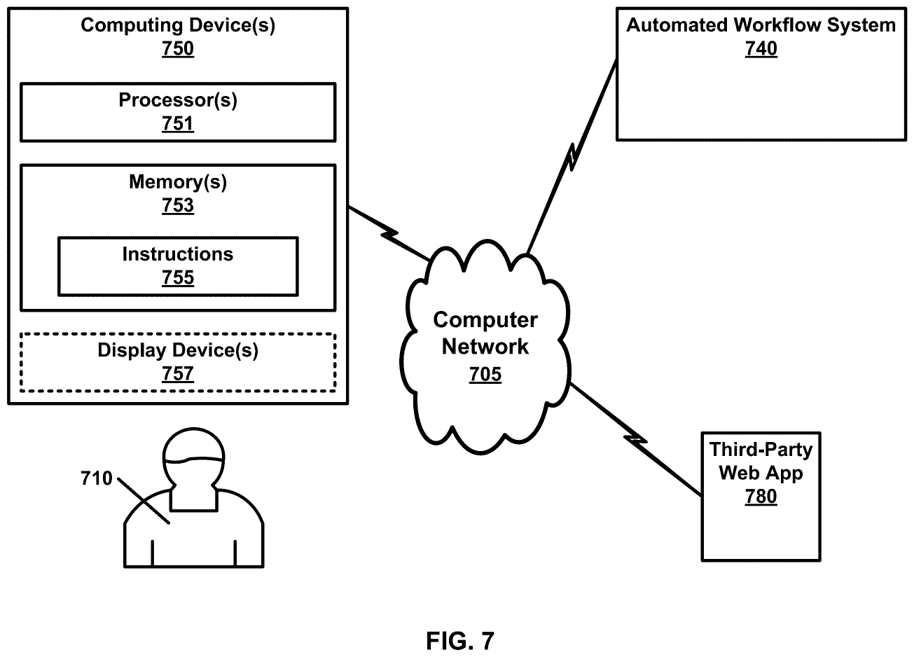

FIG. 7 depicts an example computing device 750 for automatically communicating workflow integration instructions to a system for executing workflows, consistent with disclosed embodiments. Computing device 750 may be communicatively coupled to computer network 705. The computer network 705 may be communicatively coupled to automated workflow system 740. The computer network 705 may be communicatively coupled to a third-party web app 780. The computing device 750 may comprise at least one memory 753. The at least one memory 753 may be configured to store instructions 755. The computing device 750 may comprise at least one processor 751. The at least one processor 751 may be configured to execute the instructions 755 to perform operations. The computing device 750 may comprise one or more display devices 757. The computing device 750 may be configured to present a workflow to user 710 through employment of one or more of the display devices 757.

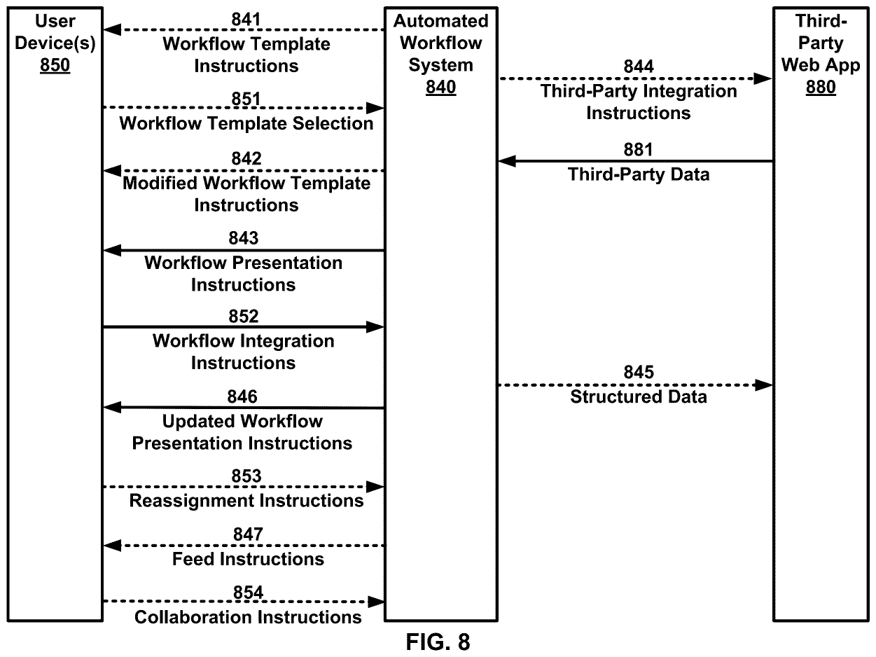

FIG. 8 depicts an example process for automatically communicating with a system for executing workflows, consistent with disclosed embodiments. At least one user device 850 may be configured to electronically receive workflow template instructions 841 from automated workflow system 840. The at least one user device 850 may be configured to automatically communicate a workflow template selection 851 to the automated workflow system 840. The at least one user device 850 may be configured to electronically receive modified workflow template instructions 842 from the automated workflow system 840. The at least one user device 850 may be configured to electronically receive workflow presentation instructions 843 from the automated workflow system 840. The at least one user device 850 may be configured to automatically communicate workflow integration instructions 852 to the automated workflow system 840. The automated workflow system 840 may be configured to communicate third-party integration instructions 844 to a third-party web app 880. The automated workflow system 840 may be configured to electronically receive third-party data 881 from the third-party web app 880. The automated workflow system 840 may be configured to communicate structured data 845 to the third-party web app 880. The at least one user device 850 may be configured to electronically receive updated workflow presentation instructions 846 from the automated workflow system 840. The at least one user device 850 may be configured to automatically communicate reassignment instructions 853 to the automated workflow system 840. The at least one user device 850 may be configured to electronically receive feed instructions 847 from the automated workflow system 840. The at least one user device 850 may be configured to automatically communicate collaboration instructions 854 to the automated workflow system 840.

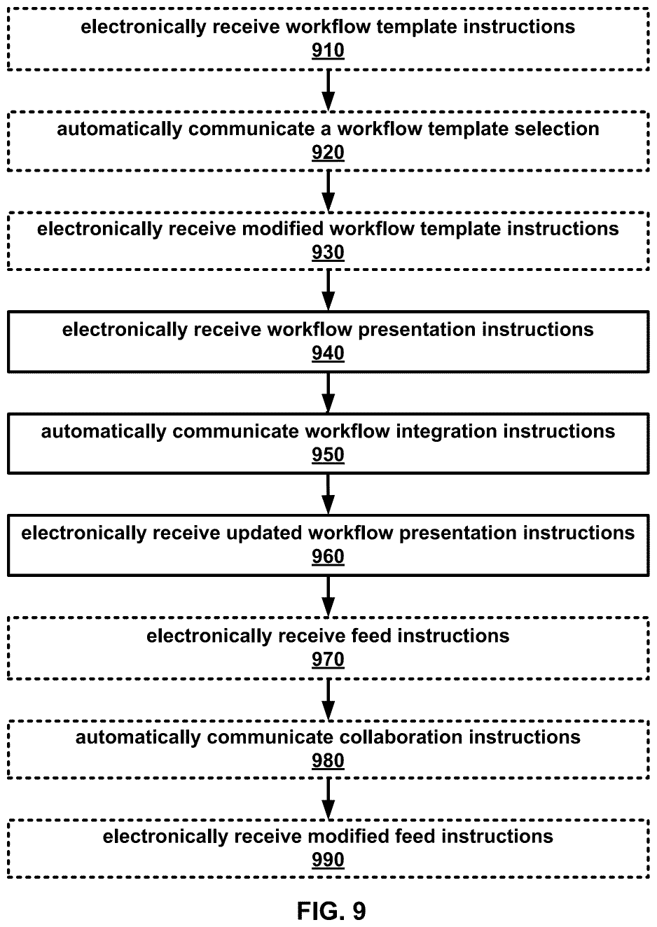

FIG. 9 depicts a second example process for automated workflow, consistent with disclosed embodiments. Workflow template instructions may be electronically received at 910.

A workflow template selection may be automatically communicated at 920. Modified workflow template instructions may be electronically received at 930. Workflow presentation instructions may be electronically received at 940. Workflow integration instructions may be automatically communicated at 950. Updated workflow presentation instructions may be electronically received at 960. Feed instructions may be electronically received at 970. Collaboration instructions may be automatically communicated at 980. Modified feed instructions may be electronically received at 990.

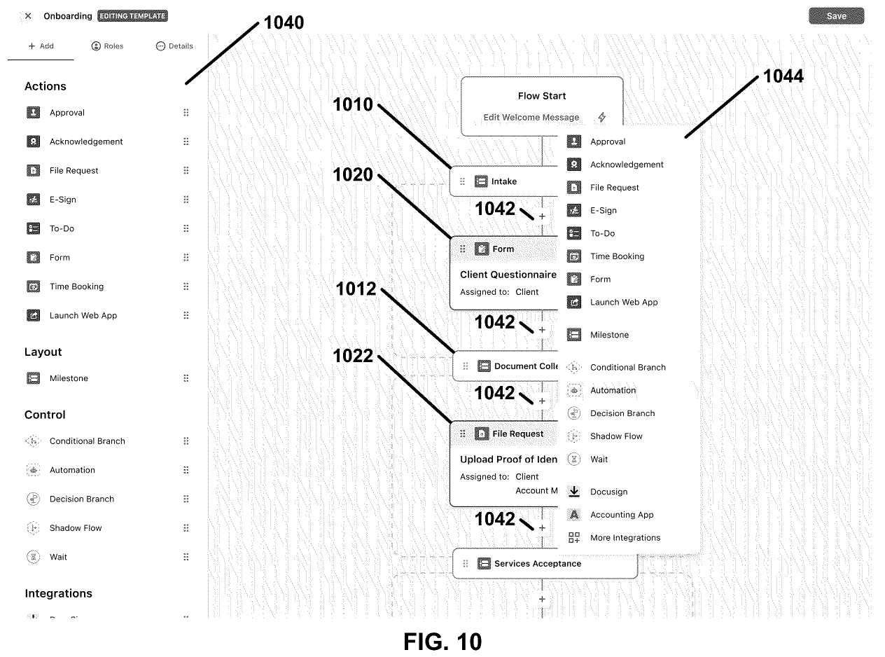

FIG. 10 illustrates an example workflow template presentation including first example options for adding items, consistent with disclosed embodiments. The workflow template presentation may illustrate a workflow with a first milestone 1010. The workflow may comprise a first user actionable item 1020. The first user actionable item 1020 may comprise a form. In this example, the form may comprise a client questionnaire. In this example, the first user actionable item 1020 is associated with the first milestone 1010. The workflow may comprise a second milestone 1012. The workflow may comprise a second user actionable item 1022. The second user actionable item 1022 may comprise a file request. In this example, the file request may comprise proof of identification. In this example, the second user actionable item 1022 is associated with the second milestone 1012. The workflow template presentation may illustrate example options for adding example items. Example items may be presented in an example items menu 1040 and/or in an example items dialog box 1044. An item from the items menu 1040 may be dragged into the workflow to quickly add the item to the workflow. The items may comprise user actionable items, layout items, control items, and/or integration items. In this example, an automation control item is selected in the items dialog box 1044. One of the items may be added into the workflow at any of one or more decision points 1042.

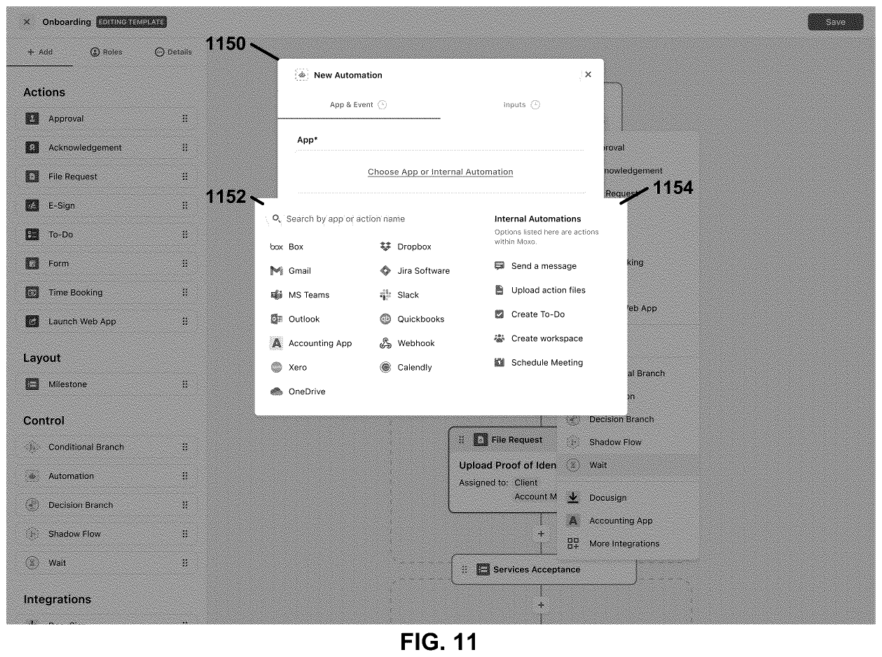

FIG. 11 illustrates example options for configuring an automation, consistent with disclosed embodiments. Dialog box 1150 may be presented when an automation control item is selected in a workflow template. A third-party web app may be selected in automation selector box 1152. Alternatively, an internal automation may be selected in internal automation options 1154. Workflow integration instructions received from a user device may comprise a selection of a third-party web app in the automation selector box 1152. The workflow integration instructions may comprise a request to integrate third-party data from a selected third-party web app into a workflow based on the workflow template.

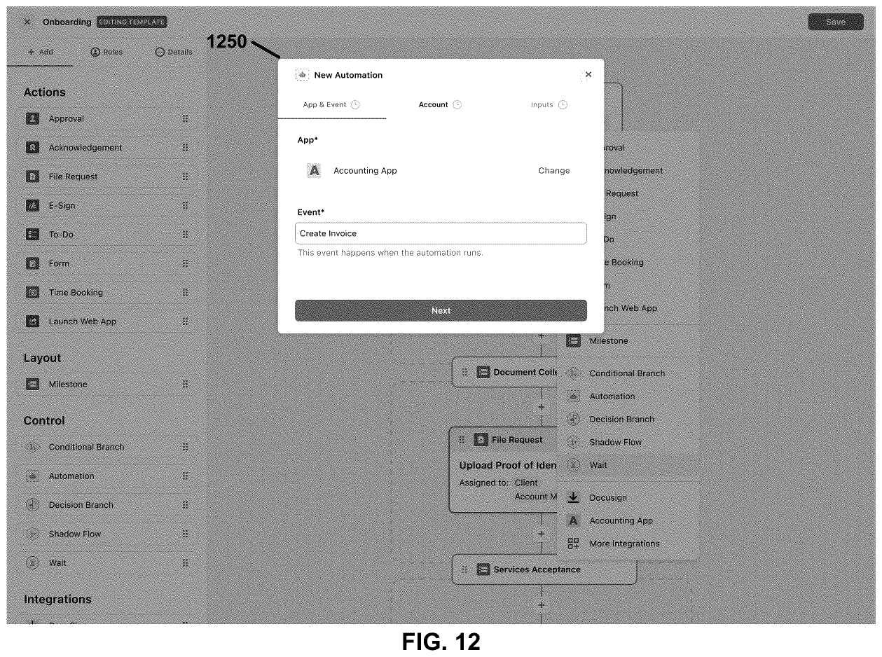

FIG. 12 illustrates example options for configuring a third-party web app event, consistent with disclosed embodiments. Dialog box 1250 may be presented after a third-party web app is selected in a new automation dialog box (e.g., 1150). The third-party web app event may be selected through employment of dialog box 1250.

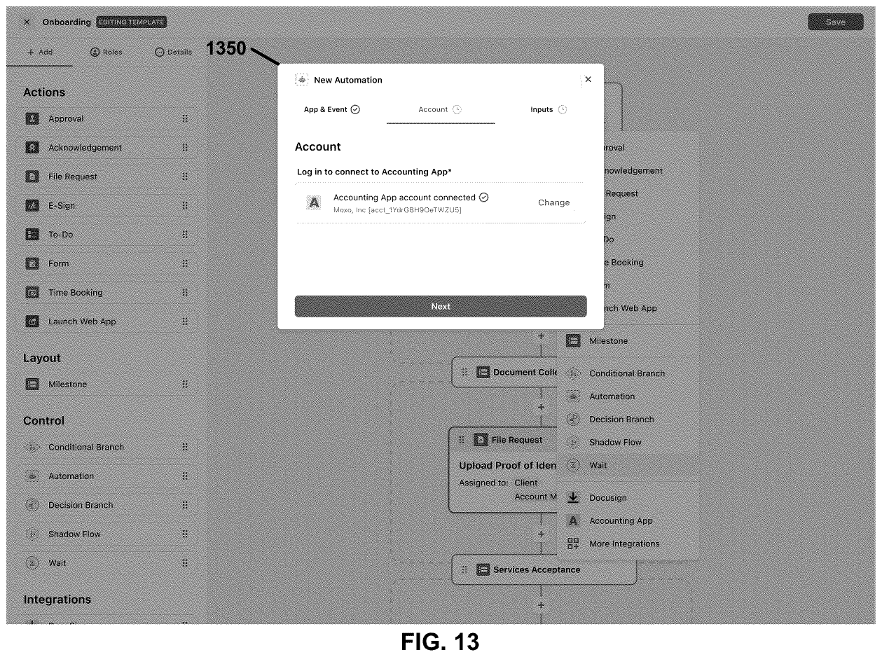

FIG. 13 illustrates example options for configuring a third-party web app account, consistent with disclosed embodiments. Dialog box 1350 may be presented after an automation event is selected in a third-party web app event dialog box (e.g., 1250). The third-party web app account may be configured automatically by logging into the third-party app.

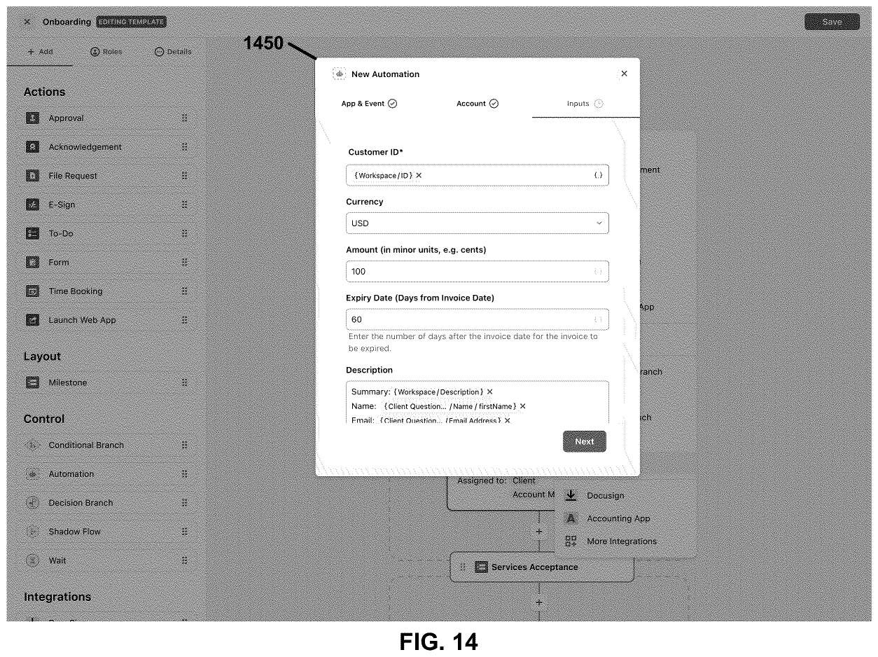

FIG. 14 illustrates example options for configuring third-party web app inputs, consistent with disclosed embodiments. Dialog box 1450 may be presented after an automation account is configured in a third-party web app account dialog box (e.g., 1350). The third-party web app inputs may be configured through employment of dialog box 1450.

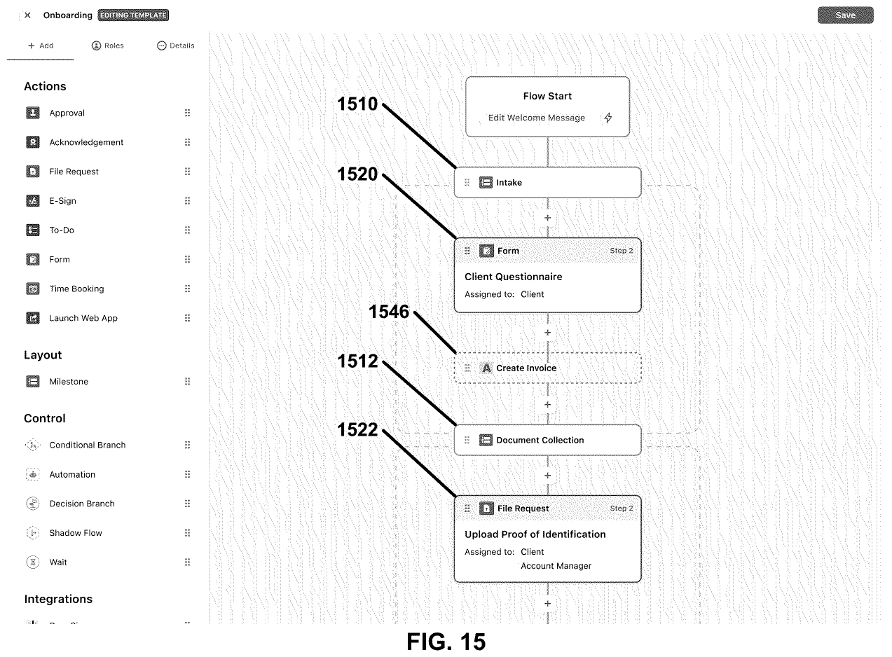

FIG. 15 illustrates an example workflow template presentation including an example system-triggered automation 1546, consistent with disclosed embodiments. The workflow template presentation may illustrate a workflow with a first milestone 1510. The workflow may comprise a first user actionable item 1520. The first user actionable item 1520 may comprise a form. In this example, the form may comprise a client questionnaire. The workflow may comprise a system-triggered automation 1546. The system-triggered automation 1546 may be automatically generated. In this example, the system-triggered automation may be related to creating an invoice in a third-party web app. In this example, the first user actionable item 1520 and the system-triggered automation 1546 are associated with the first milestone 1510. The workflow may comprise a second milestone 1512. The workflow may comprise a second user actionable item 1522. The second user actionable item 1522 may comprise a file request. In this example, the file request may comprise proof of identification. In this example, the second user actionable item 1522 is associated with the second milestone 1512.

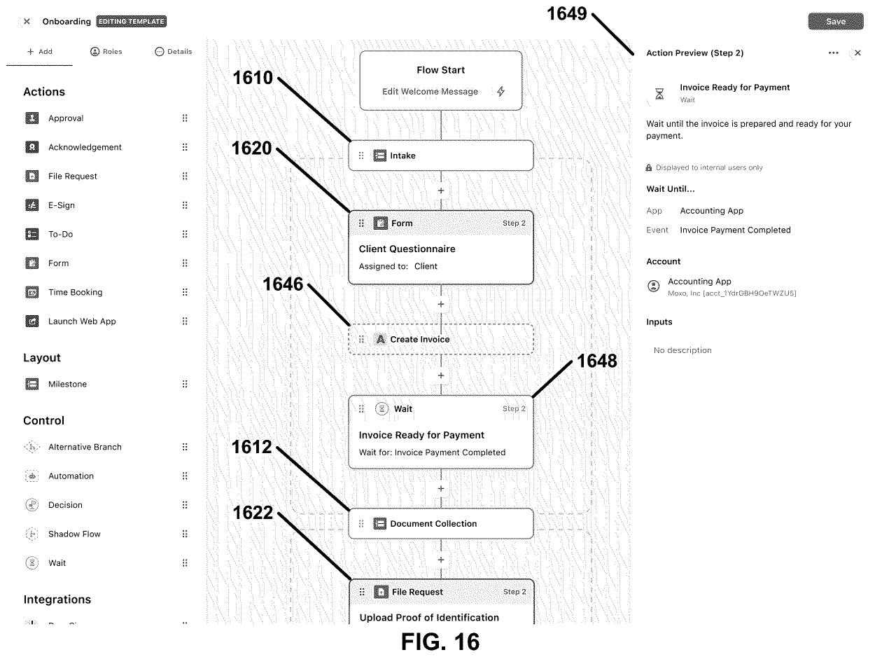

FIG. 16 illustrates an example workflow template presentation including an example wait-until control item 1648, consistent with disclosed embodiments. The workflow template presentation may illustrate a workflow with a first milestone 1610. The workflow may comprise a first user actionable item 1620. The first user actionable item 1620 may comprise a form. In this example, the form may comprise a client questionnaire. The workflow may comprise a system-triggered automation 1646. The system-triggered automation 1646 may be automatically generated. In this example, the system-triggered automation may be related to creating an invoice in a third-party web app. In this example, the third-party web app may comprise an accounting app. The workflow may comprise a wait-until control item 1648. The wait-until control item 1648 may be automatically added to the workflow. The wait-until control item 1648 may be configured to pause the workflow until third-party data is received from the third-party web app. In this example, the third-party data may comprise details of an invoice and/or invoice payment. In this example, the first user actionable item 1620, the system-triggered automation 1646, and the wait-until control item 1648 are all associated with the first milestone 1610. The workflow template presentation may illustrate an item preview dialog box 1649. The item preview dialog box 1649 may be associated with a selected item in the workflow template. In this example, the item preview dialog box 1649 is associated with the wait-until control item 1648. The workflow may comprise a second milestone 1612. The workflow may comprise a second user actionable item 1622. The second user actionable item 1622 may comprise a file request. In this example, the file request may comprise proof of identification. In this example, the second user actionable item 1622 is associated with the second milestone 1612.

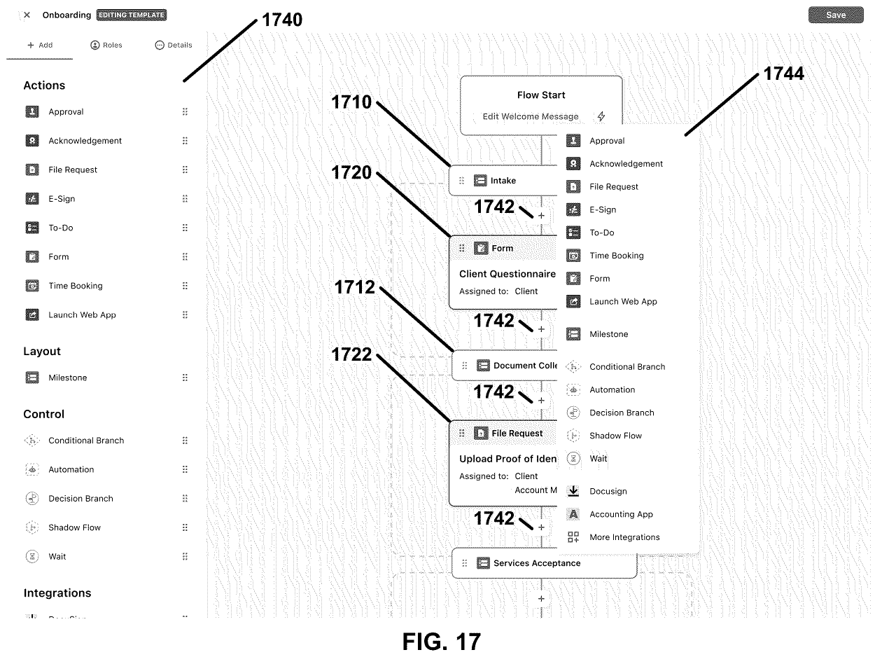

FIG. 17 illustrates an example workflow template presentation including second example options for adding items, consistent with disclosed embodiments. The workflow template presentation may illustrate a workflow with a first milestone 1710. The workflow may comprise a first user actionable item 1720. The first user actionable item 1720 may comprise a form. In this example, the form may comprise a client questionnaire. In this example, the first user actionable item 1720 is associated with the first milestone 1710. The workflow may comprise a second milestone 1712. The workflow may comprise a second user actionable item 1722. The second user actionable item 1722 may comprise a file request. In this example, the file request may comprise proof of identification. In this example, the second user actionable item 1722 is associated with the second milestone 1712. The workflow template presentation may illustrate example options for adding example items. Example items may be presented in an example items menu 1740 and/or in an example items dialog box 1744. An item from the items menu 1740 may be dragged into the workflow to quickly add the item to the workflow. The items may comprise user actionable items, layout items, control items, and/or integration items. In this example, wait-until control item is selected in the items dialog box 1744. One of the items may be added into the workflow at any of one or more decision points 1742.

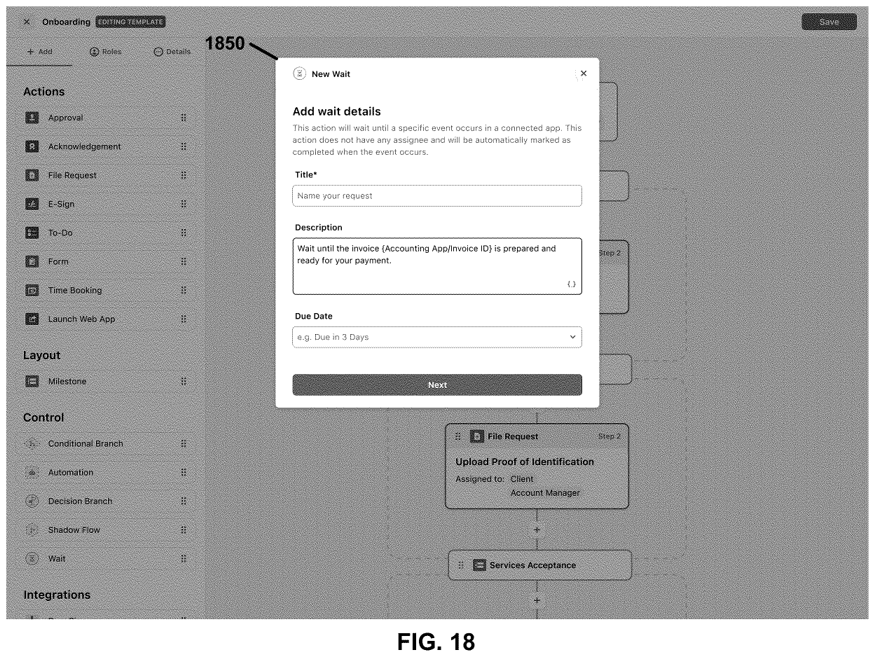

FIG. 18 illustrates example options for adding details to a wait-until control item, consistent with disclosed embodiments. Dialog box 1850 may be presented when a wait-until control item is selected in a workflow template. The wait-until control item may be configured to pause the workflow until a specific event occurs in a connected application. The connected application may comprise a third-party web app. Details may be added to the wait-until control item through employment of dialog box 1850.

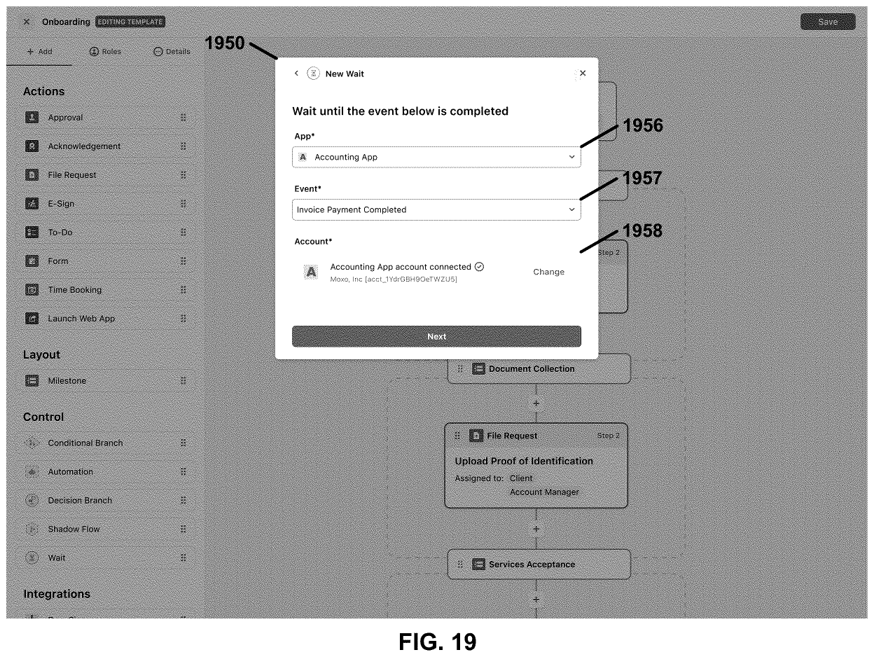

FIG. 19 illustrates example options for configuring a wait-until control item, consistent with disclosed embodiments. Dialog box 1950 may be presented after details are added to a new wait-until control item dialog box (e.g., 1850). The wait-until control item may be based on a third-party web app. The third-party web app may be selected in the third-party web app dropdown box 1956. The wait-until control item may be based on an event occurring in the third-party web app. The event may be selected in the event dropdown box 1957. The wait-until control item may be based on an account in the third-party web app. The account may be selected in the account dropdown box 1958. An integration module may be configured to communicate with the third-party web app through employment of a configured account. In this example, the third-party web app may comprise an accounting app. In this example, the wait-until control item is configured to pause the workflow until payment for an invoice in the accounting app is completed.

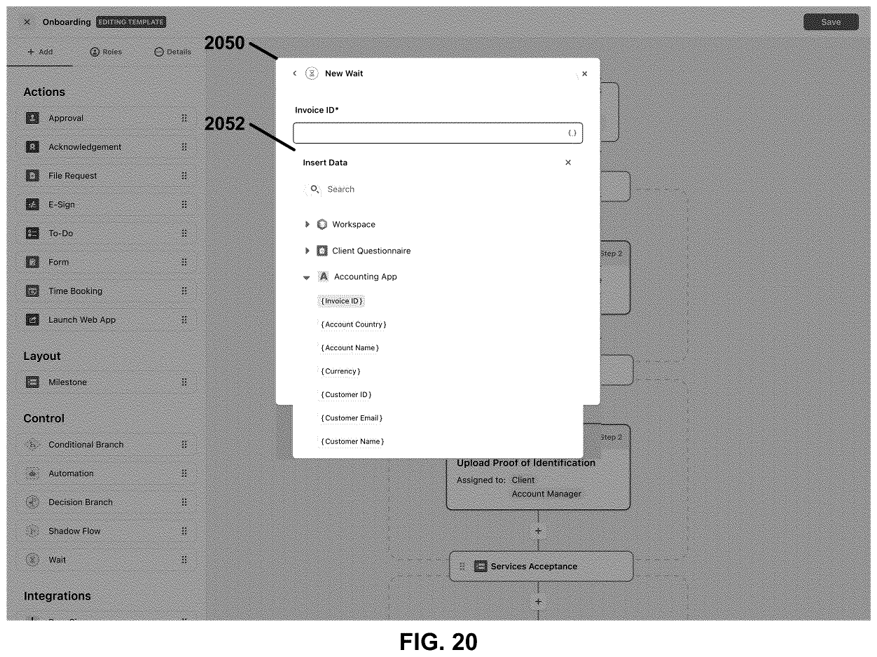

FIG. 20 illustrates example options for configuring wait-until control item data, consistent with disclosed embodiments. Dialog box 2050 may be presented after a specific event is configured in a wait-until control item configuration dialog box (e.g., 1950). Wait-until control item data may be inserted through employment of an insert data selector box 2052. In this example, a specific invoice ID may be entered as part of the wait-until control item data. The invoice ID may be associated with a third-party web app. In this example, the third-party web app may comprise an accounting app.

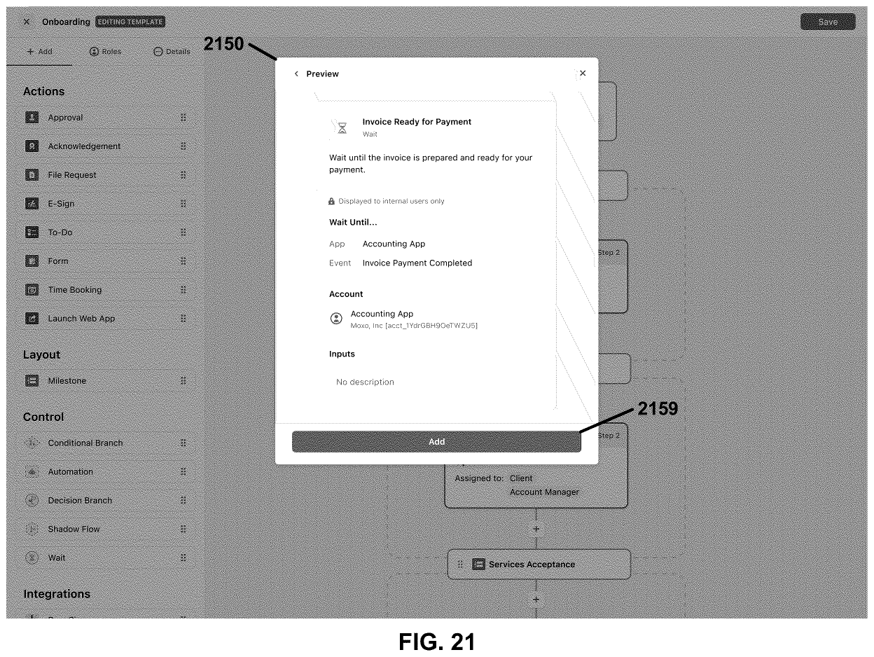

FIG. 21 illustrates an example preview for adding a wait-until control item to a workflow, consistent with disclosed embodiments. Preview box 2150 may be presented after completion of a wait-until control item data configuration dialog box (e.g., 2050). The wait-until control item may be added to the workflow after an add wait-until control item button 2159 is selected.

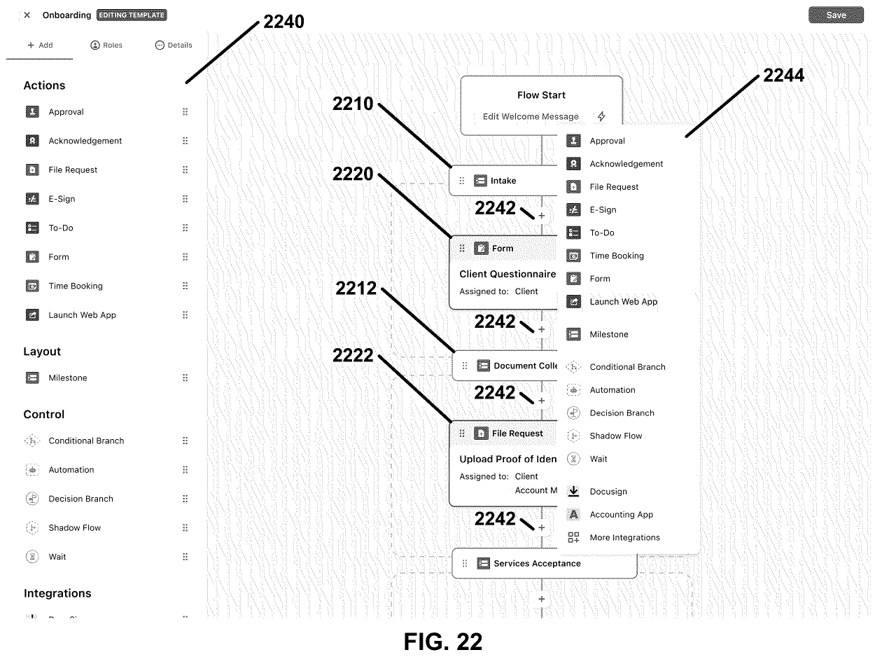

FIG. 22 illustrates an example workflow template presentation including third example options for adding items, consistent with disclosed embodiments. The workflow template presentation may illustrate a workflow with a first milestone 2210. The workflow may comprise a first user actionable item 2220. The first user actionable item 2220 may comprise a form. In this example, the form may comprise a client questionnaire. In this example, the first user actionable item 2220 is associated with the first milestone 2210. The workflow may comprise a second milestone 2212. The workflow may comprise a second user actionable item 2222. The second user actionable item 2222 may comprise a file request. In this example, the file request may comprise proof of identification. In this example, the second user actionable item 2222 is associated with the second milestone 2212. The workflow template presentation may illustrate example options for adding example items. Example items may be presented in an example items menu 2240 and/or in an example items dialog box 2244. An item from the items menu 2240 may be dragged into the workflow to quickly add the item to the workflow. The items may comprise user actionable items, layout items, control items, and/or integration items. In this example, launch web app action is selected in the items dialog box 2244. A launch web app action may be configured to launch a third-party web app once integrated into the a workflow. A launch web app action may be configured to launch an internal web app once integrated into the workflow. One of the items may be added into the workflow at any of one or more decision points 2242.

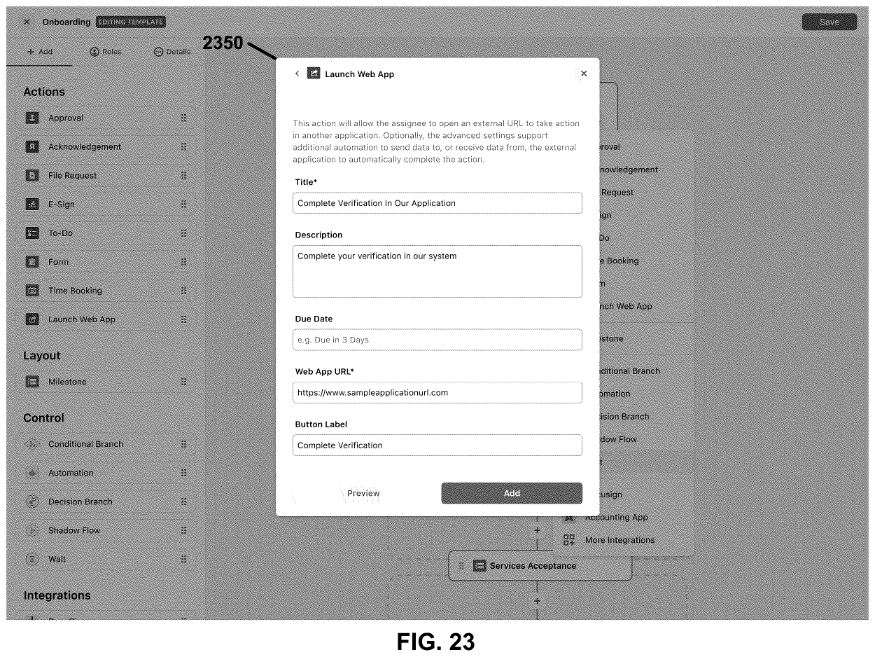

FIG. 23 illustrates example options for configuring a third-party web app, consistent with disclosed embodiments. Dialog box 2350 may be presented when a launch web app action is selected in a workflow template. The launch web app action may be configured to integrate a third-party web app into a workflow. The third-party web app may be configured through employment of dialog box 2350.

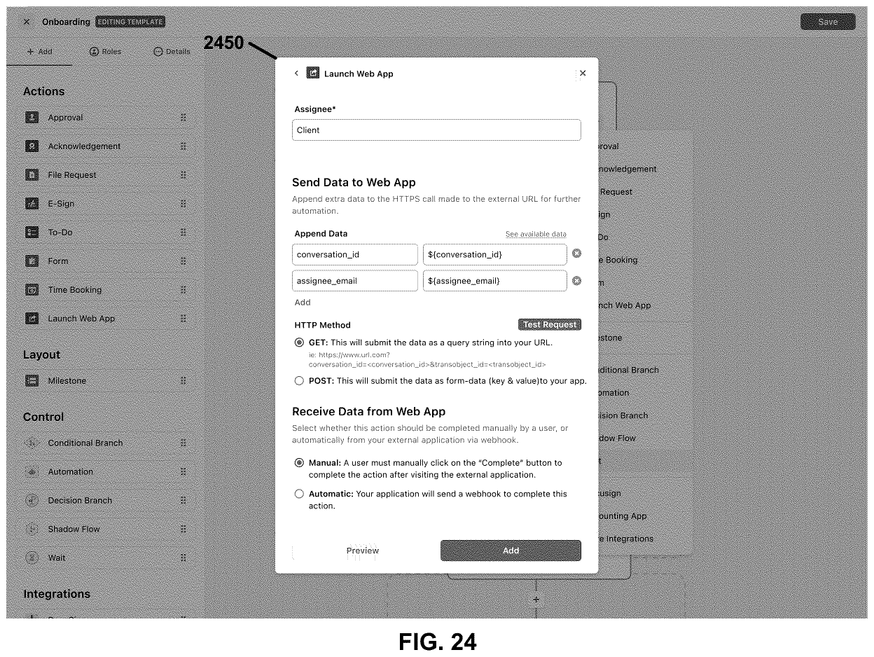

FIG. 24 illustrates example options for configuring third-party web app integration data, consistent with disclosed embodiments. Dialog box 2450 may be presented after completion of a third-party web app configuration dialog box (e.g., 2350). Configuring third-party web app integration data may include selecting workflow data to communicate to the third-party web app from a workflow. Configuring third-party web app integration data may include selecting third-party data to receive from the third-party web app. The third-party web app integration data may be configured through employment of dialog box 2450.

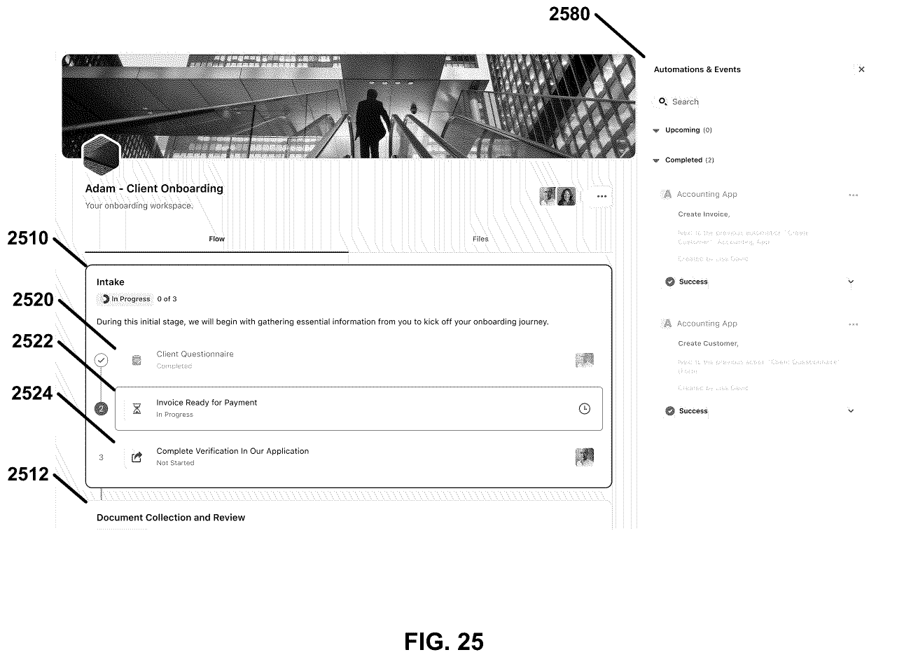

FIG. 25 illustrates an example workflow presentation including an example wait-until control item 2522 in progress and example item details 2580, consistent with disclosed embodiments. The workflow presentation may illustrate a workflow with a first milestone 2510. The workflow may comprise a user actionable item 2520. The user actionable item 2520 may comprise a form. In this example, the form may comprise a client questionnaire. The user actionable item 2520 may be marked as completed (as shown). The workflow may comprise a wait-until control item 2522. The wait-until control item 2522 may be associated with a system-triggered automation. In this example, the system-triggered automation may be configured to facilitate paying an invoice in a third-party web app. In this example, the third-party web app may comprise an accounting app. The wait-until control item 2522 may be configured to pause the workflow until third-party data is received from the third-party web app. In this example, the third-party data may comprise details of an invoice and/or invoice payment. The workflow may comprise a launch web app action 2524. In this example, the launch web app action may be configured to launch an internal web app. In this example, the internal web app may be employed to complete a verification. In this example, the user actionable item 2520, the wait-until control item 2522, and the launch web app action 2524 are all associated with the first milestone 2510. The workflow presentation may illustrate a workflow with a second milestone 2512. One of the items in the workflow may be selected by a user viewing the workflow presentation. In this example, the wait-until control item 2522 is selected. The workflow presentation may illustrate item details 2580. The item details 2580 may be associated with a selected item. In this example, the item details 2580 is associated with the wait-until control item 2522. The item details 2580 may be configured to illustrate details associated with the system-triggered automation.

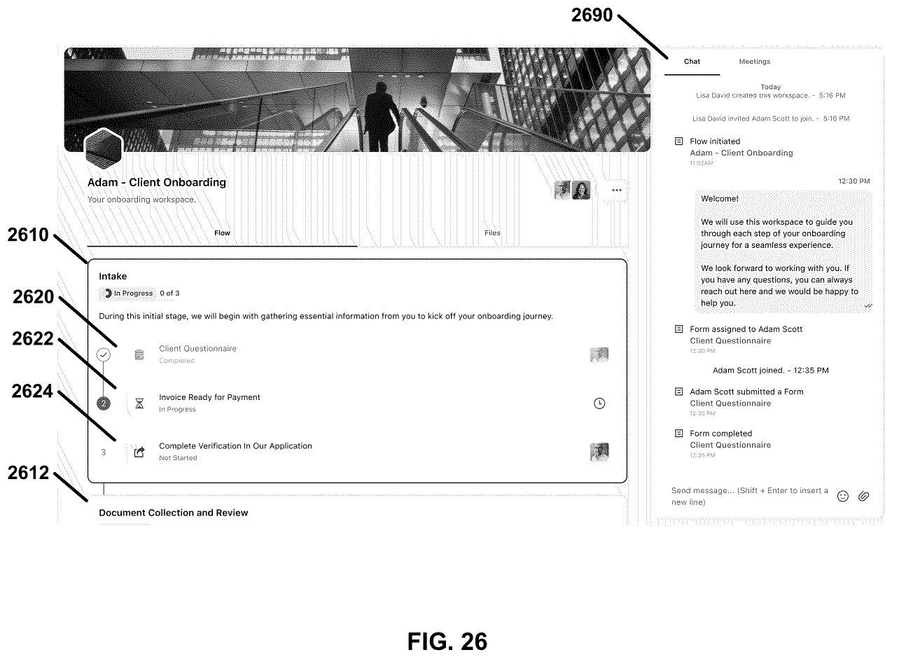

FIG. 26 illustrates an example workflow presentation including an example wait-until control item 2622 in progress and an example collaboration feed 2690, consistent with disclosed embodiments. The workflow presentation may illustrate a workflow with a first milestone 2610. The workflow may comprise a user actionable item 2620. The user actionable item 2620 may comprise a form. In this example, the form may comprise a client questionnaire. The user actionable item 2620 may be marked as completed (as shown). The workflow may comprise a wait-until control item 2622. The wait-until control item 2622 may be associated with a system-triggered automation. In this example, the system-triggered automation may be configured to facilitate paying an invoice in a third-party web app. The wait-until control item 2622 may be configured to pause the workflow until third-party data is received from the third-party web app. In this example, the third-party data may comprise details of an invoice and/or invoice payment. The workflow may comprise a launch web app action 2624. In this example, the launch web app action may be configured to launch an internal web app. In this example, the internal web app may be employed to complete a verification. In this example, the user actionable item 2620, the wait-until control item 2622, and the launch web app action 2624 are all associated with the first milestone 2610. The workflow presentation may illustrate a workflow with a second milestone 2612. The workflow presentation may illustrate a collaboration feed 2690. The collaboration feed 2690 may be associated with a selected item. In this example, the collaboration feed 2690 is associated with the first milestone 2610.

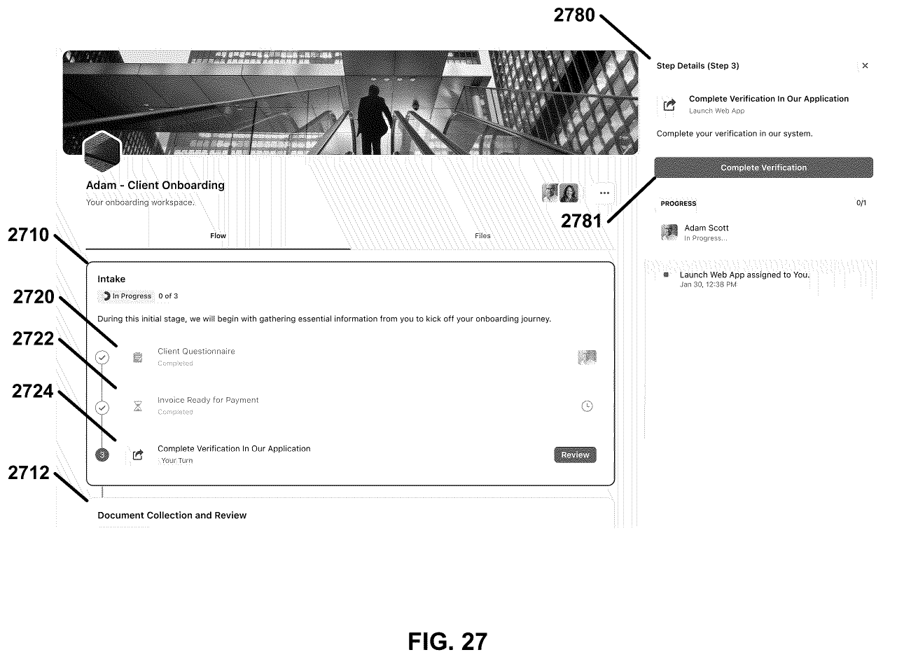

FIG. 27 illustrates an example workflow presentation including an example completed wait-until control item 2724, consistent with disclosed embodiments. The workflow presentation may illustrate a workflow with a first milestone 2710. The workflow may comprise a user actionable item 2720. The user actionable item 2720 may comprise a form. In this example, the form may comprise a client questionnaire. The user actionable item 2720 may be marked as completed (as shown). The workflow may comprise a wait-until control item 2722. The wait-until control item 2722 may be associated with a system-triggered automation. In this example, the system-triggered automation may be configured to facilitate paying an invoice in a third-party web app. The wait-until control item 2722 may be configured to pause the workflow until third-party data is received from the third-party web app. In this example, the third-party data may comprise details of an invoice and/or invoice payment. In this example, the third-party data has been received from the third-party web app as the wait-until control item 2722 is marked as completed (as shown). Therefore, in this example, the paused state of the workflow has been resolved as items subsequent to the wait-until control item 2722 are actionable. The workflow may comprise a launch web app action 2724. In this example, the launch web app action may be configured to launch an internal web app. In this example, the internal web app may be employed to complete a verification. The internal web app may require at least a portion of the third-party data received from the third-party web app. In this example, at least a portion of the third-party data received from the third-party web app may be needed to complete the verification. In this example, the user actionable item 2720, the wait-until control item 2722, and the launch web app action 2724 are all associated with the first milestone 2710. The workflow presentation may illustrate a workflow with a second milestone 2712. One of the items in the workflow may be selected by a user viewing the workflow presentation. In this example, the launch web app action 2724 is selected. The workflow presentation may illustrate item details 2780. The item details 2780 may be associated with a selected item. In this example, the item details 2780 is associated with the launch web app action 2724. The item details 2780 may comprise a call to action 2781. The call to action 2781 may be associated with an internal web app. In this example, the call to action 2781 is associated with completing a verification.

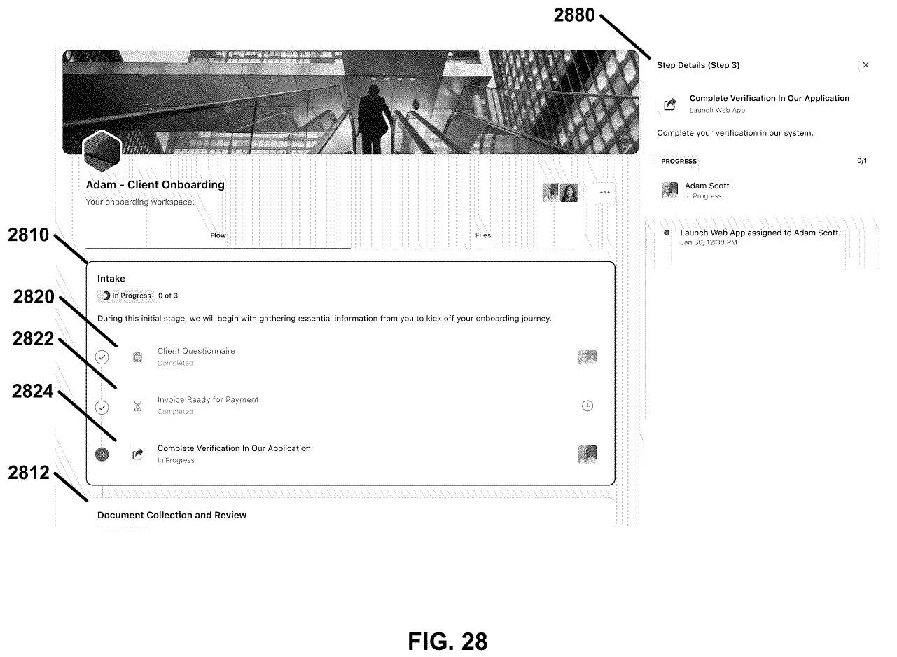

FIG. 28 illustrates an example workflow presentation including an example launch web app action 2824 in progress, consistent with disclosed embodiments. The workflow presentation may illustrate a workflow with a first milestone 2810. The workflow may comprise a user actionable item 2820. The user actionable item 2820 may comprise a form. In this example, the form may comprise a client questionnaire. The user actionable item 2820 may be marked as completed (as shown). The workflow may comprise a wait-until control item 2822. The wait-until control item 2822 may be associated with a system-triggered automation. In this example, the system-triggered automation may be configured to facilitate paying an invoice in a third-party web app. The wait-until control item 2822 may be configured to pause the workflow until third-party data is received from the third-party web app. In this example, the third-party data may comprise details of an invoice and/or invoice payment. In this example, the third-party data has been received from the third-party web app as the wait-until control item 2822 is marked as completed (as shown). Therefore, in this example, the paused state of the workflow has been resolved as items subsequent to the wait-until control item 2822 are actionable. The workflow may comprise a launch web app action 2824. In this example, the launch web app action may be configured to launch an internal web app. In this example, the internal web app may be employed to complete a verification. The internal web app may require at least a portion of the third-party data received from the third-party web app. In this example, at least a portion of the third-party data received from the third-party web app may be needed to complete the verification. In this example, the user actionable item 2820, the wait-until control item 2822, and the launch web app action 2824 are all associated with the first milestone 2810. The workflow presentation may illustrate a workflow with a second milestone 2812. One of the items in the workflow may be selected by a user viewing the workflow presentation. In this example, the launch web app action 2824 is selected. The workflow presentation may illustrate item details 2880. The item details 2880 may be associated with a selected item. In this example, the item details 2880 is associated with the launch web app action 2824. Once the launch web app action 2824 has started, the launch web app action 2824 may be marked as in progress (as shown).

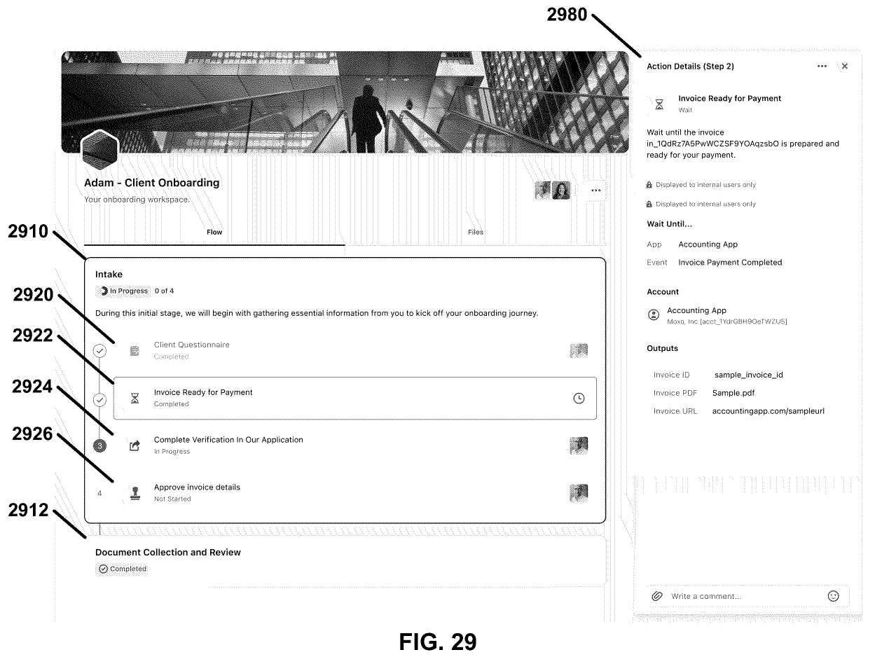

FIG. 29 illustrates an example workflow presentation including an example completed wait-until control item 2922 and example item details 2980, consistent with disclosed embodiments. The workflow presentation may illustrate a workflow with a first milestone 2910. The workflow may comprise a first user actionable item 2920. The first user actionable item 2920 may comprise a form. In this example, the form may comprise a client questionnaire. The first user actionable item 2920 may be marked as completed (as shown). The workflow may comprise a wait-until control item 2922. The wait-until control item 2922 may be associated with a system-triggered automation. In this example, the system-triggered automation may be configured to facilitate paying an invoice in a third-party web app. In this example, the third-party web app may comprise an accounting app. The wait-until control item 2922 may be configured to pause the workflow until third-party data is received from the third-party web app. In this example, the third-party data may comprise details of an invoice and/or invoice payment. In this example, the third-party data has been received from the third-party web app as the wait-until control item 2922 is marked as completed (as shown). Therefore, in this example, the paused state of the workflow has been resolved as items subsequent to the wait-until control item 2922 are actionable. The workflow may comprise a launch web app action 2924. In this example, the launch web app action may be configured to launch an internal web app. In this example, the internal web app may be employed to complete a verification. The internal web app may require at least a portion of the third-party data received from the third-party web app. In this example, at least a portion of the third-party data received from the third-party web app may be needed to complete the verification. The workflow may comprise a second user actionable item 2926. The second user actionable item 2926 may comprise an approval. In this example, the approval may comprise approving invoice details. The second user actionable item 2926 may require at least a portion of the third-party data received from the third-party web app. In this example, at least a portion of the third-party data received from the third-party web app may be needed to complete the approval. In this example, the first user actionable item 2920, the wait-until control item 2922, the launch web app action 2924, and the second user actionable item 2926 are all associated with the first milestone 2910. The workflow presentation may illustrate a workflow with a second milestone 2912. One of the items in the workflow may be selected by a user viewing the workflow presentation. In this example, the wait-until control item 2922 is selected. The workflow presentation may illustrate item details 2980. The item details 2980 may be associated with a selected item. In this example, the item details 2980 is associated with the wait-until control item 2922. The item details 2980 may illustrate details associated with the selected item. When the selected item is a wait-until control item 2922, the item details 2980 may illustrate details associated with the system-triggered automation. When the selected item is a wait-until control item 2922, the item details 2980 may illustrate details associated with the third-party web app. When the selected item is a wait-until control item 2922, the item details 2980 may illustrate details associated with the third-party data. In this example, the details associated with the third-party data is illustrated in the outputs section of the item details 2980.

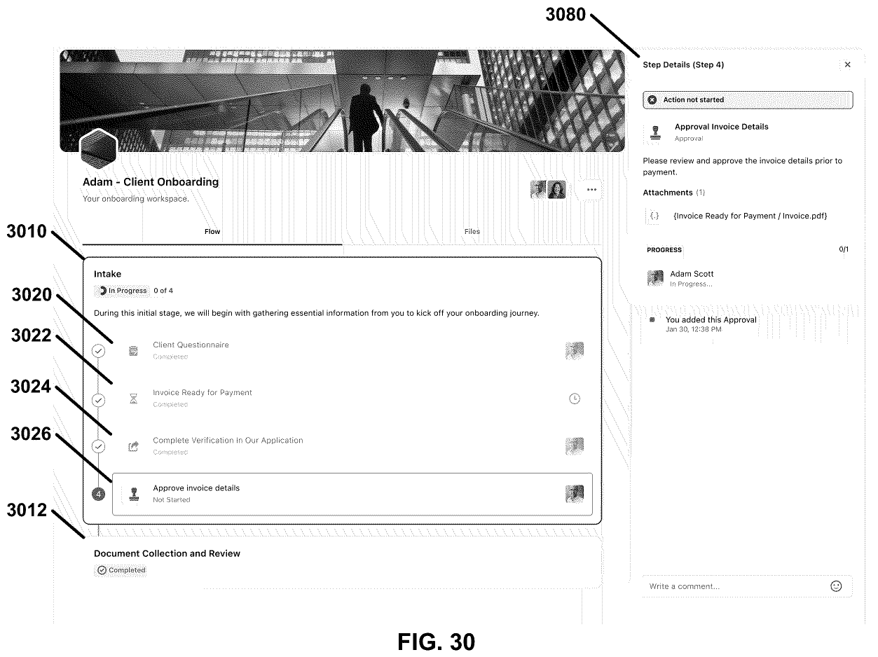

FIG. 30 illustrates an example workflow presentation including an example subsequent user actionable item 3026 and example item details 3080, consistent with disclosed embodiments. The workflow presentation may illustrate a workflow with a first milestone 3010. The workflow may comprise a first user actionable item 3020. The first user actionable item 3020 may comprise a form. In this example, the form may comprise a client questionnaire. The first user actionable item 3020 may be marked as completed (as shown). The workflow may comprise a wait-until control item 3022. The wait-until control item 3022 may be associated with a system-triggered automation. In this example, the system-triggered automation may be configured to facilitate paying an invoice in a third-party web app. The wait-until control item 3022 may be configured to pause the workflow until third-party data is received from the third-party web app. In this example, the third-party data may comprise details of an invoice and/or invoice payment. In this example, the third-party data has been received from the third-party web app as the wait-until control item 3022 is marked as completed (as shown). Therefore, in this example, the paused state of the workflow has been resolved as items subsequent to the wait-until control item 3022 are actionable. The workflow may comprise a launch web app action 3024. In this example, the launch web app action 3024 may be configured to launch an internal web app. In this example, the internal web app may be employed to complete a verification. The internal web app may require at least a portion of the third-party data received from the third-party web app. In this example, at least a portion of the third-party data received from the third-party web app may have been needed to complete the verification. The launch web app action 3024 may be marked as completed (as shown). The workflow may comprise a subsequent user actionable item 3026. The subsequent user actionable item 3026 may comprise an approval. In this example, the approval may comprise approving invoice details. The subsequent user actionable item 3026 may require at least a portion of the third-party data received from the third-party web app. In this example, at least a portion of the third-party data received from the third-party web app may be needed to complete the approval. In this example, the first user actionable item 3020, the wait-until control item 3022, the launch web app action 3024, and the subsequent user actionable item 3026 are all associated with the first milestone 3010. The workflow presentation may illustrate a workflow with a second milestone 3012. One of the items in the workflow may be selected by a user viewing the workflow presentation. In this example, the subsequent user actionable item 3026 is selected. The workflow presentation may illustrate item details 3080. The item details 3080 may be associated with a selected item. In this example, the item details 3080 is associated with the subsequent user actionable item 3026. The item details 3080 may illustrate details associated with the selected item. The item details 3080 may include a link to an attachment. The third-party data may comprise the attachment.

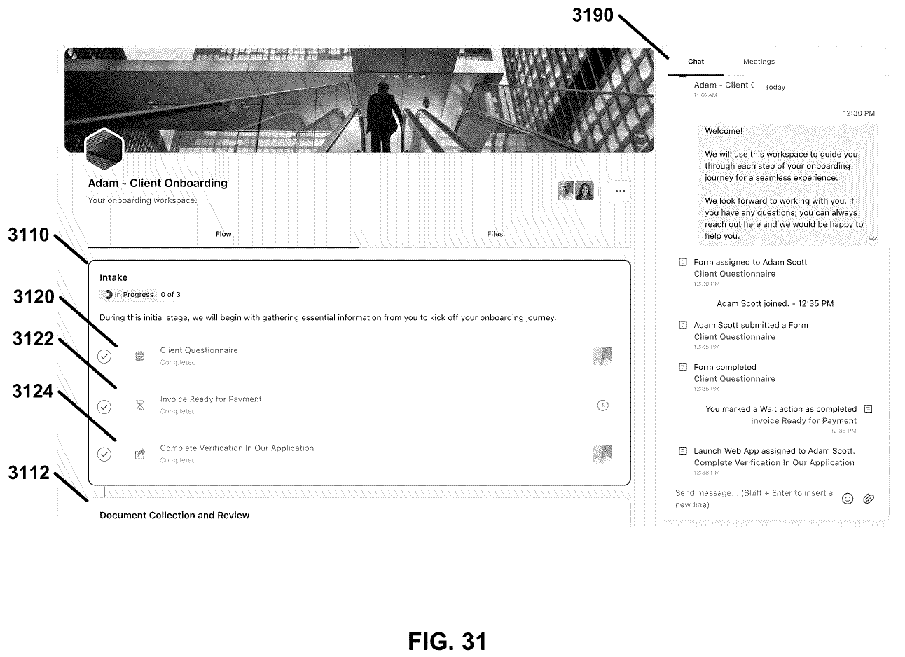

FIG. 31 illustrates an example workflow presentation including an example completed launch web app 3124, consistent with disclosed embodiments. The workflow presentation may illustrate a workflow with a first milestone 3110. The workflow may comprise a first user actionable item 3120. The first user actionable item 3120 may comprise a form. In this example, the form may comprise a client questionnaire. The first user actionable item 3120 may be marked as completed (as shown). The workflow may comprise a wait-until control item 3122. The wait-until control item 3122 may be associated with a system-triggered automation. In this example, the system-triggered automation may be configured to facilitate paying an invoice in a third-party web app. The wait-until control item 3122 may be configured to pause the workflow until third-party data is received from the third-party web app. In this example, the third-party data may comprise details of an invoice and/or invoice payment. In this example, the third-party data has been received from the third-party web app as the wait-until control item 3122 is marked as completed (as shown). The workflow may comprise a launch web app action 3124. In this example, the launch web app action 3124 may be configured to launch an internal web app. In this example, the internal web app may be employed to complete a verification. The internal web app may require at least a portion of the third-party data received from the third-party web app. In this example, at least a portion of the third-party data received from the third-party web app may have been needed to complete the verification. The launch web app action 3124 may be marked as completed (as shown). In this example, the first user actionable item 3120, the wait-until control item 3122, and the launch web app action 3124 are all associated with the first milestone 3110. The workflow presentation may illustrate a workflow with a second milestone 3112. The workflow presentation may illustrate a collaboration feed 3190. The collaboration feed 3190 may be associated with a selected item. In this example, the collaboration feed 3190 is associated with the first milestone 3110.

Although the subject matter has been described in language specific to structural features and/or methodological acts, it is to be understood that the subject matter defined in the appended claims is not necessarily limited to the specific features or acts described above.

Rather, the specific features and acts described above are disclosed as example forms of implementing the claims.

In this specification, “a” and “an” and similar phrases are to be interpreted as “at least one” and “one or more.” References to “a”, “an”, and “one” are not to be interpreted as “only one”. In this specification, the term “may” is to be interpreted as “may, for example.” In other words, the term “may” is indicative that the phrase following the term “may” is an example of one of a multitude of suitable possibilities that may, or may not, be employed to one or more of the various embodiments. In this specification, the phrase “based on” is indicative that the phrase following the term “based on” is an example of one of a multitude of suitable possibilities that may, or may not, be employed to one or more of the various embodiments. References to “an” embodiment in this disclosure are not necessarily to the same embodiment.

Many of the elements described in the disclosed embodiments maybe implemented as operations. An operation is defined herein as an isolatable element that performs a defined function and has a defined interface to other elements. The operations described in this disclosure may be implemented in hardware, software, a combination of hardware and software, firmware, wetware (in other words, hardware with a biological element), or a combination thereof, all of which are behaviorally equivalent. For example, operations may be implemented using computer hardware in combination with software routine(s) written in a computer language (for example, Java, HTML, XML, PHP, Python, ActionScript, JavaScript, Ruby, Prolog, SQL, VBScript, Visual Basic, Perl, C, C++, Objective-C, Rust, and/or any other computer language). Additionally, it may be possible to implement operations using physical hardware that incorporates discrete or programmable analog, digital, and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers, and microprocessors may be programmed using languages such as assembly, C, C++, and/or any other computer language. FPGAs, ASICs, and CPLDs are often programmed using hardware description languages (HDL) such as VHSIC hardware description language (VHDL) or Verilog that configure connections between internal hardware operations with lesser functionality on a programmable device. Finally, it needs to be emphasized that the above-mentioned technologies may be used in combination to achieve the result of a functional operation. Automatic operations are performed automatically and do not require human intervention to complete once executed. Automatic as defined herein does not include any time limitations unless otherwise noted.

Some embodiments may employ processing hardware. Processing hardware may comprise one or more processors, microprocessors, computer equipment, embedded systems, machines, and/or the like. Processing hardware may comprise one or more single core or multiple core processors that executes parallel processes simultaneously. For example, a processor may be a single core processor configured with virtual processing technologies. In some embodiments, a processor may use logical processors to simultaneously execute and control multiple processes. Processing hardware may implement virtual machine technologies, or other known technologies to provide the ability to execute, control, run, manipulate, and/or store multiple software processes, applications, programs, and/or the like. In another example, a processor may include a multiple core processor arrangement (e.g., dual core, quad core, etc.) configured to provide parallel processing functionalities to allow execution of multiple processes simultaneously. One of ordinary skill in the art would understand that other types of processor arrangements could be implemented that provide for the capabilities disclosed herein. The disclosed embodiments are not limited to any type of processor.

Some embodiments may employ programs. Programs may comprise instructions configured to cause processing hardware to perform operations. Programs may include one or more programs (e.g., modules, code, scripts, or functions) used to perform methods consistent with disclosed embodiments. Programs may include operating systems that perform known operating system functions when executed by one or more processors. Disclosed embodiments may operate and function with computer systems running any type of operating system.

Programs may be written in one or more programming or scripting languages. In some embodiments, programs may be implemented or replicated as firmware or circuit logic. The programs and/or instructions may be stored on a machine-readable medium or memory. A memory (e.g., automated data medium) may be a medium configured to store data in a machine-readable format that may be accessed by an automated sensing device. According to some embodiments, a memory may include a volatile or nonvolatile, magnetic, semiconductor, optical, removable, non-removable, or other type of storage device or tangible (i.e., non-transitory) computer readable medium, consistent with disclosed embodiments. A memory may comprise data, instructions, programs, and/or other components.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described example embodiments. In particular, it should be noted that, for example purposes, various embodiments include a system for executing workflows and a user device. However, one skilled in the art will recognize that the system and user device may vary from a traditional server/device relationship over a network such as the internet. For example, a system may be collective based: portable equipment, broadcast equipment, virtual, application(s) distributed over a broad combination of computing sources, part of a cloud, and/or the like. Similarly, for example, a user device may be a computing device, a user based client, portable equipment, broadcast equipment, virtual, application(s) distributed over a broad combination of computing sources, part of a cloud, and/or the like. Additionally, it should be noted that, for example purposes, several of the various embodiments include instructions. However, one skilled in the art will recognize that many various languages and frameworks may be employed to build and use embodiments of the present invention.

In this specification, various embodiments are disclosed. Limitations, features, and/or elements from the disclosed example embodiments may be combined to create further embodiments within the scope of the disclosure. Moreover, the scope includes any and all embodiments having equivalent elements, modifications, omissions, adaptations, or alterations based on the present disclosure. Further, aspects of the disclosed methods can be modified in any manner, including by reordering aspects, or inserting or deleting aspects.

In addition, it should be understood that any figures that highlight any functionality and/or advantages, are presented for example purposes only. The disclosed architecture is sufficiently flexible and configurable, such that it may be utilized in ways other than that shown. For example, the blocks presented in any flowchart may be re-ordered or only optionally used in some embodiments.

Furthermore, many features presented above are described as being optional through the use of “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A system for executing workflows comprising user actionable items and at least one system-triggered automation, the system comprising:
a) a workflow template database being configured to store a plurality of workflow templates, each of the workflow templates comprising a workflow having a sequence of user actionable items;
b) at least one memory storing instructions; and
c) at least one processor being configured to execute the instructions to perform operations, the operations comprising:
i) automatically communicating workflow template presentation instructions to a first user device, the workflow template presentation instructions being configured to present a workflow template to a user of the first user device;
ii) electronically receiving workflow integration instructions from the first user device, the workflow integration instructions comprising a request to integrate third-party data from a third-party web app into the workflow;
iii) automatically generating a system-triggered automation associated with the workflow, the system-triggered automation generated through employment of an integration module being configured to communicate with the third-party web app;
iv) automatically adding a wait-until control item to the workflow template, the wait-until control item being configured to pause the workflow until the third-party data is received from the third-party web app;
v) dynamically updating the workflow template presentation instructions to include the wait-until control item in the workflow;
vi) automatically communicating workflow presentation instructions to a second user device, the workflow presentation instructions being configured to present the workflow based on the workflow template to a user of the second user device;
vii) automatically completing the wait-until control item upon receiving the third-party data from the third-party web app;
viii) automatically passing at least a portion of the third-party data to one or more subsequent user actionable items in the workflow; and
ix) dynamically updating the workflow presentation instructions to include the third-party data and updated status of: the wait-until control item and the one or more subsequent user actionable items.

2. The system according to claim 1, wherein the user actionable items comprise one or more of the following:
a) a form;
b) a file request;
c) an approval;
d) an acknowledgment;
e) a signature;
f) a calendar item;
g) a task; or
h) an integration.

3. The system according to claim 1, wherein one or more of the user actionable items is dynamically assignable to one or more users based on one or more workflow roles.

4. The system according to claim 1, wherein the system-triggered automation includes one or more of:
a) creating records in the third-party web app;
b) updating records in the third-party web app;
c) retrieving and processing data from the third-party web app;
d) triggering an event in the third-party web app; or
e) triggering an operation in the third-party web app.

5. The system according to claim 1, the operations further comprising dynamically retrieving, referencing, and utilizing data from one or more of the user actionable items through employment of a Dynamic Data Reference (DDR) module to prepare a new user actionable item.

6. The system according to claim 1, the operations further comprising dynamically retrieving, referencing, and utilizing data from the system-triggered automation through employment of a Dynamic Data Reference (DDR) module to prepare a new user actionable item.

7. The system according to claim 1, further comprising a Dynamic Data Reference (DDR) module being configured to:
a) dynamically retrieve, reference, and utilize workflow data from one of the user actionable items to prepare a new user actionable item; and
b) automatically populate the new user actionable item through employment of the third-party data.

8. The system according to claim 1, further comprising a Dynamic Data Reference (DDR) module being configured to:
a) dynamically retrieve, reference, and utilize workflow data from the system-triggered automation to prepare a new user actionable item;
b) automatically validate the workflow data against prior item outputs; and
c) automatically populate the new user actionable item through employment of the third-party data.

9. The system according to claim 1, further comprising a wait-until control item module being configured to:
a) automatically introduce a paused state in workflow progression until the third-party data is received from the third-party web app;
b) automatically listen for and retrieve the third-party data from the third-party web app; and
c) dynamically update dependent workflow items based on the third-party data and resolve the paused state.

10. The system according to claim 1, further comprising an automation module being configured to:
a) electronically communicate structured data from one or more of the user actionable items to the third-party web app automatically; and
b) automatically retrieve and process the third-party data from the third-party web app.

11. The system according to claim 1, further comprising a launch web app module being configured to:
a) automatically add a launch web app action to the workflow template;
b) dynamically communicate one or more third-party web app requests from the first user device to the integration module;
c) automatically communicate workflow data retrieved from one or more previous user actionable items to the integration module; and
d) automatically retrieve and process the third-party data from the third-party web app.

12. The system according to claim 1, further comprising a workflow management module being configured to automatically communicate:
a) completion of the user actionable items and the system-triggered automation;
b) current status of the wait-until control item or pending third-party data; and
c) a dependency between items consisting of one of the following:
i) a first of the user actionable items and a second of the user actionable items; or
ii) one of the user actionable items and the system-triggered automation.

13. A computer-implemented method of executing workflows comprising user actionable items and at least one system-triggered automation, the method comprising:
a) defining a workflow comprising a sequence of user actionable items;
b) automatically communicating workflow template presentation instructions to a first user device, the workflow template presentation instructions being configured to present a workflow template to a user of the first user device;
c) electronically receiving workflow integration instructions from the first user device, the workflow integration instructions comprising a request to integrate third-party data from a third-party web app into the workflow;
d) automatically generating a system-triggered automation associated with the workflow, the system-triggered automation in communication with the third-party web app;
e) automatically adding a wait-until control item to the workflow template, the wait-until control item being configured to pause the workflow until the third-party data is received from the third-party web app;
f) dynamically updating the workflow template presentation instructions to include the wait-until control item in the workflow;
g) automatically communicating workflow presentation instructions to a second user device, the workflow presentation instructions being configured to present the workflow based on the workflow template to a user of the second user device;
h) automatically completing the wait-until control item upon receiving the third-party data from the third-party web app;
i) automatically passing at least a portion of the third-party data to one or more subsequent user actionable items in the workflow; and
j) dynamically updating the workflow presentation instructions to include the third-party data and updated status of: the wait-until control item and the one or more subsequent user actionable items.

14. The method according to claim 13, further comprising dynamically retrieving, referencing, and utilizing data from one or more user actionable items in the workflow in a new user actionable item.

15. The method according to claim 13, further comprising dynamically retrieving, referencing, and utilizing data from the system-triggered automation associated with the workflow in a new user actionable item.

16. The method according to claim 13, further comprising dynamically retrieving, referencing, and utilizing workflow data from one of the user actionable items to prepare a new user actionable item, and automatically populating the new user actionable item through employment of the third-party data.

17. The method according to claim 13, further comprising dynamically retrieving, referencing, and utilizing workflow data from the system-triggered automation to prepare a new user actionable item, automatically validating the workflow data against prior item outputs, and automatically populating the new user actionable item through employment of the third-party data.

18. The method according to claim 13, further comprising automatically introducing a paused state in workflow progression until the third-party data is received from the third-party web app, automatically listening for and retrieving the third-party data from the third-party web app, dynamically updating dependent workflow items based on the third-party data, and resolving the paused state.

19. The method according to claim 13, further comprising electronically communicating structured data from one or more of the user actionable items to the third-party web app automatically, and automatically retrieving and processing the third-party data from the third-party web app.

20. The method according to claim 13, further comprising automatically adding a launch web app action to the workflow template, dynamically communicating one or more third-party web app requests from the first user device to the third-party web app, automatically communicating workflow data retrieved from one or more previous user actionable items to the third-party web app, and automatically retrieving and processing the third-party data from the third-party web app.
